(19) United States
(12) Patent Application Publication
(10) Pub. No.: US 2009/0000519 A1
(43) Pub. Date: Jan. 1, 2009

(54) Coatings Reparable by Energy Discharge

(75) Inventors: Reinhold Schwalm, Wachenheim (DE); Nick Gruber, Mannheim (DE); Lydie Tuchbreiter, Speyer (DE); Gabriele Dlugosch, Worms (DE); Frank Vollinger, Knoringen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, LUDWIGSHAFEN (DE)

(21) Appl. No.: 12/162,129

(22) PCT Filed: Jan. 23, 2007
(86) PCT No.: PCT/EP07/50641

§ 371 Date: Jul. 25, 2008

(30) Foreign Application Priority Data
Feb. 3, 2006 (EP) 06101258.9

(51) Int. Cl. C04B 16/00; C08L 79/00; C07F 7/18; C07F 7/02; C08G 77/14; C08G 77/06; C08L 75/04

(52) U.S. Cl. 106/481; 525/452; 556/462; 556/450; 528/28; 528/26; 556/420

(57) ABSTRACT

Coating compositions repairable by introduction of energy and comprising defined siloxanes, coatings obtained therewith and repairable by introduction of energy, methods of producing them, and their use.

The present invention relates to coating compositions repairable by introduction of energy and comprising defined siloxanes, to coatings obtained therewith and repairable by introduction of energy, to methods of producing them, and to their use.

WO 96/10595 A1 describes self-healing coatings which comprise urethane prepolymers whose constituent components comprise inter alia carbinol-terminated polyalkylsiloxanediol segments. The structures disclosed include, in particular, siloxanediols terminated with ethylene oxide or propylene oxide. The siloxanediols used in the examples have about 12-13 Si—O groups.

Coatings based on polyurethanes are likewise used in order to heal scratches on glass. They make use of the flowability of the polyurethanes in the film. For this utility, mention may be made, by way of example, of U.S. Pat. No. 4,584,229, EP 135404 A1, DE 2634816, and EP 635348 A1.

All of the prior-art self-healing coating systems described to date make use solely of a physical residual flowability of a coating after curing in order to heal scratches that have formed. Sufficiently high flowability of the coatings, however, presupposes a low crosslinking density. This leads to inadequate mechanical resistance properties, failing, for example, to meet the requirements for automotive applications in terms of scratch resistance or chemical resistance.

Only EP 355 028 A describes true chemical self-healing of a coating. In this case a lower coating film comprises an aromatic ketone, which on UV exposure or under the effect of sunlight brings about the crosslinking of lower coating films and hence produces healing of mechanical defects through the formation of new chemical bonds. A disadvantageous effect here is the deficient selectivity in the forging of new crosslinking points, since crosslinking may progress in the coating and then leads to embrittlement.

The use of polysiloxanes for improving the scratch resistance of coatings is known for example from U.S. Pat. No. 5,916,992 and EP-B1 1204701.

A disadvantage of polysiloxanes of this kind is that they do not enable coatings to self-heal.

Mono- and disiloxanes which carry one or two phenolic groups are known from U.S. Pat. No. 3,328,450. A disadvantage is that no use whatsoever is described for these compounds.

The German patent application with the file reference 10 2005 034213.2 and the filing date of Jul. 19, 2005 describes self-healing coatings whose self-healing is based on cleavage of cleavable reaction products of isocyanates. Products containing siloxane groups are not disclosed.

It is an object of the present invention to provide coatings which are repairable by introduction of energy, whose scratch resistance at least matches that of the known, prior-art coatings and whose repairability, brought about by means of introduction of energy, is improved as compared with that of comparable coatings.

This object is achieved by means of coating compositions comprising as constituent components
(A) at least one compound having at least one silicon atom and at least one isocyanate-reactive group (Y) whose reaction product with isocyanate is more readily cleavable than the corresponding reaction product with a compound having primary hydroxyl groups, and also, if appropriate, having at least one further isocyanate-reactive group (Z), which is different from (Y), and
(B) at least one nonblocked or blocked di- or polyisocyanate.

Cleavage of the bond between isocyanate groups and groups (Y) is accomplished by introduction of heat and/or high-energy radiation and/or by application of pressure, preferably by introduction of heat and/or high-energy radiation, and more preferably by introduction of heat, such as thermally or by NIR radiation, for example. Under the cleavage conditions the groups (Y) and also isocyanate groups are at least partly reformed and can be newly linked again. In the cleaved state, therefore, the coating material is more readily flowable than the coating, scratches are able to heal by flow of the relatively low-viscosity coating composition, and after the end of the introduction of energy the coating composition is able to crosslink once again by renewed forging of the bonds between the groups (Y) and isocyanate groups.

For the purposes of this text the term coating composition means the uncured composition comprising coating medium (binder) and, if appropriate, pigment and/or other, typical coatings additives.

The coating means the applied and dried and/or cured coating composition.

The term “readily cleavable” means here that the cleavage reaction of the reaction product into groups (Y) and isocyanate groups under the selected reaction conditions takes place at a rate which is more rapid than that of the cleavage of the corresponding reaction product with a compound having primary hydroxyl groups, especially methanol.

The compounds (A) of the invention comprise at least one, preferably at least two isocyanate-reactive groups (Y) whose reaction product with isocyanate is readily cleavable, and also, if appropriate, at least one further isocyanate-reactive group (Z).

In one alternative embodiment compounds (A) may be a mixture of compounds comprising exclusively in each case at least one, preferably at least two isocyanate-reactive groups (Y) with compounds comprising exclusively isocyanate-reactive groups (Z).

In a further alternative embodiment the compounds (A) may be compounds each comprising precisely one group (Y) and precisely one group (Z).

It represents a particular advantage of compounds (A) of the invention which comprise at least one group (Y) and at least one group (Z) in one molecule that the groups (Y) which have undergone cleavage are unable to escape from the coating since they are still joined via groups (Z) to the isocyanate-functional component (B).

Isocyanate-reactive groups (Y) whose reaction product is readily cleavable with isocyanate are groups of the kind used for blocking isocyanate groups.

Groups of this kind are described in D. A. Wicks, Z. W. Wicks, Progress in Organic Coatings, 36, 148-172 (1999), 41, 1-83 (2001), and 43, 131-140 (2001).

Preferred groups (Y) are phenols, imidazoles, triazoles, pyrazoles, oximes, N-hydroxyimides, hydroxybenzoic esters, secondary amines, lactams, CH-acidic cyclic ketones, malonic esters or alkyl acetoacetates.

Imidazolic groups as groups reactive toward isocyanate groups, identified here in abbreviated form as “imidazoles”, are known for example from WO 97/12924 and EP 159117; triazoles from U.S. Pat. No. 4,482,721; CH-acidic cyclic ketones are described for example in DE-A1 102 60 269, particularly in paragraph [0008] therein and preferably in paragraphs [0033] to [0037], more preferably cyclopentanone-2-carboxylic esters, and particularly ethyl cyclopentanone-2-carboxylate.

Preferred imidazoles are, for example, imidazoles comprising not only the free NH group but also a further functional group, such as —OH, —SH, —NH—R, —NH₂, and/or —CHO, examples being 4-(hydroxymethyl)imidazole, 2-mercaptoimidazole, 2-amino-imidazole, 1-(3-aminopropyl)imidazole, 4,5-diphenyl-2-imidazolethiol, histamine, 2-imidazolecarboxaldehyde, 4-imidazolecarboxylic acid, 4,5-imidazoledicarboxylic acid, L-histidine, L-carnosine, and 2,2′-bis(4,5-dimethylimidazole).

Suitable triazoles are 3-amino-1,2,4-triazole, 4-amino-1,2,4-triazole, 3,5-diamino-1,2,4-triazole, 1H-1,2,4-triazole-3-thiol, 5-methyl-1H-1,2,4-triazole-3-thiol and 3-amino-5-mercapto-1,2,4-triazole.

Secondary amines are preferably tert-butylbenzylamine.

Preference is given to phenols, oximes, N-hydroxyimides, lactams, imidazoles, triazoles, malonic esters, and alkyl acetonates, particular preference to lactams, phenols, imidazoles, triazoles, and malonic esters, and very particular preference to phenols.

The compounds (A) of the invention comprise on average at least one, preferably at least 2, more preferably 2 to 20, very preferably 2 to 10, in particular 2 to 6, especially 2 to 4, often 2 to 3, and even precisely 2 groups (Y).

Groups (Y) can be present in compound (A) in amounts up to 5 mol/kg of compound (A), preferably 0.1 to 5 mol, more preferably 0.3 to 4.5 mol, very preferably 0.5 to 4 mol, and in particular 1 to 3 mol/kg.

The compounds (A) may optionally further comprise at least one, one to six for example, preferably one to four, more preferably one to three, very preferably one to two, and in particular precisely one further isocyanate-reactive group (Z).

Preferred compounds (A), though, contain no further groups (Z).

Groups (Z) are isocyanate-reactive groups which are other than the groups (Y). They may be, for example, primary hydroxyl, secondary hydroxyl, tertiary hydroxyl, primary amino or mercapto groups, preferably primary hydroxyl or primary amino groups, and more preferably primary hydroxyl groups.

Primary hydroxyl groups are hydroxyl groups attached to a carbon atom which is joined to precisely one other carbon atom. Similarly, in the case of secondary hydroxyl groups, the carbon atom attached to them is joined, correspondingly, to two carbon atoms, and in the case of tertiary hydroxyl groups to three carbon atoms.

The carbon atoms to which the hydroxyl groups are attached may be cycloaliphatic or aliphatic carbon atoms, i.e., part of a cycloaliphatic ring system or of a linear or branched chain, but not of an aromatic ring system.

Primary amino groups are amino groups which are joined via a carbon atom having precisely one substituent, and thus have precisely two hydrogen atoms joined to the nitrogen atom.

Furthermore, in accordance with the invention, the compounds (A) contain at least one silicon atom, preferably 1 to 50, more preferably 2 to 40, very preferably 3 to 30, in particular 3 to 20, especially 4 to 10, even 4 to 8, and often 5 to 7 silicon atoms.

In the compounds (A) the silicon atoms can be present in the form of silane groups, i.e., organosilicon groups composed of silicon atoms and hydrogen atoms—that is, composed of silicon atoms substituted by any desired alkyl, aryl or cycloalkyl groups, or, preferably, in the form of siloxanes, in other words compounds comprising at least one Si—O—Si moiety (siloxane bond), the silicon atoms in that case being able to be substituted by any alkyl, aryl or cycloalkyl groups. Structures of this kind are occasionally also referred to as silicones, in other words compounds in which silicon atoms are linked, via oxygen atoms, in the form of chains and/or nets, and the remaining valences of the silicon are satisfied by hydrocarbon radicals.

Preferred compounds (A) are those obtainable by reacting at least one compound (A1) having at least one silicon atom and at least one Si—H group with at least one compound (A2) which carries at least one group (Y) and at least one vinylic group.

Preferred compounds (A1) have 1 to 6, preferably 1 to 4, more preferably 1 to 3, very preferably 1 to 3, in particular 1 to 2, and especially 2 Si—H groups.

Preferred compounds (A1) have 1 to 50, preferably 2 to 40, more preferably 3 to 30, very preferably 3 to 20, in particular 4 to 10, especially 4 to 8, and even 5 to 7 silicon atoms.

In one preferred embodiment the compounds (A1) comprise at least one organic polysiloxane hydride of formula (I)

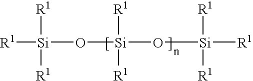

in which
R¹ radicals can each independently be hydrogen, hydroxyl (—OH), C₁-C₁₈ alkyl, C₆-C₁₂ aryl, C₅-C₁₂ cycloalkyl, C₁-C₁₈ alkoxy, or C₆-C₁₂ aryloxy, and
n can be an integer from 0 to 100,
in which at least one of the groups R¹ is hydrogen.

In the compounds of the formula (I) the ratio of groups R¹ which are hydrogen to groups R¹ which are not hydrogen is preferably 0.1:1 to 10:1.

With particular preference the compounds (A1) comprise at least one organic polysiloxane hydride of formula (II)

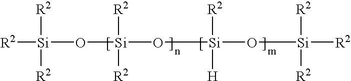

or formula (III)

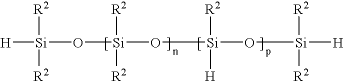

in which
R² radicals can each independently be hydroxyl (—OH), C₁-C₁₈ alkyl, C₆-C₁₂ aryl, C₅-C₁₂ cycloalkyl, C₁-C₁₈ alkoxy, and C₆-C₁₂ aryloxy,
n can be an integer from 0 to 50,
m can be an integer from 1 to 50, and
p can be an integer from 0 to 50.

In the compounds of the formula (II) or (III) the ratio of hydrogen atoms attached to silicon atoms to groups R² is preferably 0.1:1 to 10:1.

Therein the

C₁-C₁₈ Alkyl is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl or 1,1,3,3-tetra-methylbutyl.

C₁-C₁₈ Alkoxy is for example methoxy, ethoxy, n-propyloxy, iso-propyloxy, n-butyloxy, iso-butyloxy, sec-butyloxy or tert-butyloxy.

C₆-C₁₂ Aryl is for example phenyl, tolyl, xylyl, α-naphthyl, β-naphthyl, 4-biphenylyl, methylphenyl, dimethylphenyl, trimethylphenyl, ethylphenyl, diethylphenyl, iso-propylphenyl, tert-butylphenyl, dodecylphenyl, methylnaphthyl, isopropylnaphthyl, 6-dimethylphenyl or 2,4,6-trimethylphenyl.

C₅-C₁₂ Cycloalkyl is for example cyclopentyl, cyclohexyl, cyclooctyl, cyclododecyl, methylcyclopentyl, dimethylcyclopentyl, methylcyclohexyl, dimethylcyclohexyl, diethylcyclohexyl or butylcyclohexyl.

C₆-C₁₂ Aryloxy is for example phenyloxy, o-, m- or p-tolyloxy.

Preferably R¹ and R² each independently are hydroxyl, C₁-C₁₈ alkyl, C₁-C₁₈ alkoxy or C₆-C₁₂ aryl, more preferably C₁-C₄ alkyl or phenyl, very preferably C₁-C₄ alkyl.

C₁ to C₄ Alkyl for the purposes of this specification is methyl, ethyl, propyl, isopropyl, n-butyl, sec-butyl or tert-butyl, preferably methyl, ethyl, n-butyl or tert-butyl, more preferably methyl or ethyl, and very preferably methyl.

n is preferably an integer from 1 to 50, more preferably from 1 to 30, very preferably from 2 to 20, in particular from 2 to 10, and especially from 3 to 5,

m is preferably an integer from 1 to 30, more preferably from 1 to 20, very preferably from 1 to 10, in particular from 1 to 5, and especially m is 1, and

p is preferably an integer from 0 to 30, more preferably from 0 to 20, very preferably from 0 to 10, in particular from 0 to 5, and especially p is 0.

Examples of polysiloxane hydrides are 1,1,3,3-tetramethyldisiloxane, polysiloxane hydrides in which n is 3 or 4, which are available commercially under the trade name Masilwax® BASE from PPG Industries Inc.

The formulae (I), (II), and (III) are schematic, and it is not intended to indicate that the moieties in parentheses are necessarily blocks, although blocks can be used where it is desired. In many cases the compound has a more or less statistical construction, particularly if more than a few siloxane units are used, and if mixtures are used. In those cases where more than a few siloxane units are used, and it is desired to form blocks, first of all oligomers are formed, and they are then joined to form the block compound. Through a reasonable selection of reactants it is possible to use compounds having an alternating structure, or blocks of alternating structure.

The compounds of the formula (I), (II) or (III) can therefore be alternating, random or block polymers, preferably random or block polymers, and more preferably random polymers.

The compounds (A2) may preferably be those of the formula (IV)

Vin-R⁴—Y

in which
Vin is a vinylic group,
R⁴ is a single bond, an oxygen atom, a nitrogen atom, C₁-C₂₀ alkylene, C₆-C₁₂ arylene, C₃-C₁₂ cycloalkylene, or C₂-C₂₀ alkylene which is interrupted by one or more oxygen and/or sulfur atoms and/or by one or more substituted or unsubstituted imino groups and/or by one or more —(CO)—, —O(CO)O—, —(NH)(CO)O—, —O(CO)(NH)—, —O(CO)— or —(CO)O— groups, and
Y is a group (Y).

Particular preference is given to compounds (A2) of the formula (V)

Vin-R⁵—C₆-C₁₂arylene-OH

in which
Vin is as defined above and
R⁵ is a single bond, an oxygen atom, a nitrogen atom or C₁-C₂₀ alkylene,
the radicals R⁵ and —OH each being attached to carbon atoms of the C₆-C₁₂ arylene group that are part of the aromatic ring system.

Very particular preference is given to compounds (A2) of the formula (VI)

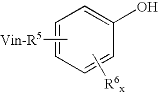

in which Vin and R⁵ are as defined above,
R⁶ radicals each independently are x like or different radicals selected from the group consisting of hydroxyl (—OH), C₁-C₂₀ alkyl, C₁-C₂₀ alkyloxy, and C₆-C₁₂ aryloxy, and
x is an integer from 0 to 4.

Therein, C₁-C₂₀ alkylene is linear or branched alkylene, such as methylene, 1,2-ethylene, 1,2- or 1,3-propylene, 1,2-, 1,3- or 1,4-butylene, 1,1-dimethyl-1,2-ethylene, 1,2-dimethyl-1,2-ethylene, 1,5-pentylene, 1,6-hexylene, 1,8-octylene, 1,10-decylene or 1,12-dodecylene,

C₃-C₁₂ cycloalkylene is for example cyclopropylene, cyclopentylene, cyclohexylene, cyclooctylene or cyclododecylene,

C₆-C₁₂ arylene is for example 1,2-, 1,3- or 1,4-phenylene, tolylene, xylylene, 4,4′-biphenylene or naphthylene, and

Vin is an α,β-unsaturated C═C double bond, preferably a vinyl group (—CH═CH₂), prop-1-en-1-yl group (—CH═CH—CH₃) or prop-1-en-2-yl group (H₂C═C(CH₃)—), more preferably a vinyl group (—CH═CH₂) or prop-1-en-1-yl group (—CH═CH—CH₃), and very preferably a vinyl group (—CH═CH₂).

R⁴ and R⁵ are each independently of one another preferably a single bond, an oxygen atom or C₁-C₂₀ alkylene, more preferably a single bond or C₁-C₂₀ alkylene, and very preferably C₁-C₂₀ alkylene. In particular R⁴ and R⁵ are each independently of one another methylene.

R⁶ is preferably hydroxyl (—OH), C₁-C₂₀ alkyl or C₁-C₂₀ alkyloxy, more preferably C₁-C₂₀ alkyl or C₁-C₂₀ alkyloxy, very preferably methyl or methoxy, and in particular methoxy.

x is preferably 0 or 1.

The radicals R⁵ and OH in formula (VI) may be positioned ortho, meta or para to one another, preferably ortho or para, and more preferably ortho if x=0 and para if x≠0.

The radicals R⁶ and OH in formula (VI) may be positioned ortho, meta or para to one another, unless the respective position is occupied by the radical R⁵; preferably ortho.

Preferred compounds (A2) are o-, m-, and p-allylphenol, eugenol (4-allyl-2-methoxy-phenol) and isoeugenol (2-methoxy-4-(1′-propenyl)phenol), particular preference being given to o-allylphenol and eugenol (4-allyl-2-methoxyphenol), and very particular preference being given to o-allylphenol.

Accordingly the following compounds constitute one preferred subject of the present invention:

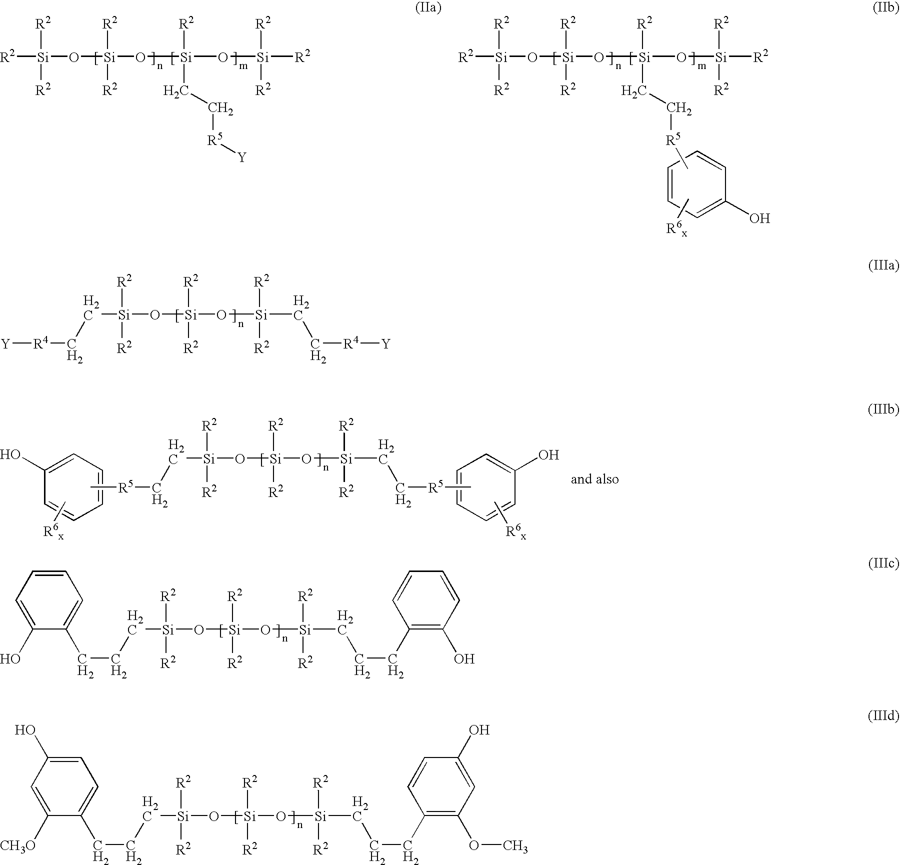

in which
R², R⁴, R⁵, R⁶, Y, n, m and x are as defined above.

The preparation of the compounds (A) is carried out typically as follows. The compound (A2) or a mixture thereof is added at ambient temperature to a reaction vessel which is equipped with a means of maintaining an inert gas blanket, preferably nitrogen or argon. At the same time about 25 to 75 ppm of sodium bicarbonate or metal acetate salt are added in order to inhibit possible unwanted side reactions, such as those associated with acetal condensation via a propenyl ether group. The temperature is raised to about 75° C. up to about 80° C. under an inert gas blanket, during which time about 5% of the polysiloxane (A1) comprising silicon hydride are added with stirring. A catalyst, such as a transition metal, e.g., nickel, nickel salts, iridium salts, and, with further preference, a noble metal from group VIII, such as chloroplatinic acid with particular preference, is then added, and the reaction is left to run exothermically at up to 95° C. The addition of the remaining portion of the polysiloxane (A1) comprising silicon hydride is completed, when the reaction temperature is held at 80 to 85° C. The reaction can be monitored by infrared spectroscopy for the disappearance of the absorption band of the silicon hydride (Si—H: 2150 cm⁻¹).

Besides the binder component (A) there is additionally present in the coating composition of the invention at least one further component (B) which comprises at least one nonblocked or blocked di- or polyisocyanate.

The compounds in question may be monomers or oligomers of aromatic, aliphatic or cycloaliphatic diisocyanates, preferably of aliphatic or cycloaliphatic diisocyanates.

The NCO functionality of such a compound is generally at least 1.8 and can be up to 8, preferably 1.8 to 5, and more preferably 2 to 4.

Suitable polyisocyanates include polyisocyanates containing isocyanurate groups, polyisocyanates containing uretdione groups, polyisocyanates containing biuret groups, polyisocyanates containing urethane groups or allophanate groups, polyisocyanates comprising oxadiazinetrione groups or iminooxadiazinedione groups, uretonimine-modified polyisocyanates, synthesized from linear or branched C₄-C₂₀ alkylene diisocyanates, cycloaliphatic diisocyanates having a total of 6 to 20 carbon atoms or aromatic diisocyanates having a total of 8 to 20 carbon atoms, or mixtures thereof.

The diisocyanates are preferably isocyanates having 4 to 20 carbon atoms. Examples of typical diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradeca-methylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)-methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4-, or 2,6-diiso-cyanato-1-methylcyclohexane, and also 3 (or 4), 8 (or 9)-bis(isocyanatomethyl)tricyclo-[5.2.1.0^{2,6}]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diiso-cyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate.

Mixtures of said diisocyanates may also be present.

Also suitable are higher isocyanates, having on average more than 2 isocyanate groups. Examples include triisocyanates such as triisocyanatononane, 2,4,6-triiso-cyanatotoluene, triphenylmethane triisocyanate or 2,4,4′-triisocyanatodiphenyl ether, or the mixtures of diisocyanates, triisocyanates, and higher polyisocyanates for example that are obtained by phosgenating corresponding aniline/formaldehyde condensates and represent polyphenyl polyisocyanates containing methylene bridges.

The di- and polyisocyanates which can be used preferably have an isocyanate group (calculated as NCO, molecular weight =42) content of 10% to 60% by weight, based on the di- and polyisocyanate (mixture), preferably 15% to 60% by weight, and more preferably 20% to 55% by weight.

Preference is given to aliphatic and/or cycloaliphatic di- and polyisocyanates, qualified collectively as (cyclo)aliphatic for the purposes of this specification, examples being the aliphatic and/or cycloaliphatic diisocyanates stated above, or mixtures thereof.

Particular preference is given to hexamethylene diisocyanate, 1,3-bis-(isocyanatomethyl)cyclohexane, isophorone diisocyanate, and 4,4′- or 2,4′-di-(isocyanatocyclohexyl)methane, very particular preference to isophorone diisocyanate and hexamethylene diisocyanate, and especial preference to hexamethylene diisocyanate.

Isophorone diisocyanate is usually in the form of a mixture, specifically a mixture of the cis and trans isomers, generally in a proportion of about 60:40 to 80:20 (w/w), preferably in a proportion of about 70:30 to 75:25, and more preferably in a proportion of approximately 75:25.

Dicyclohexylmethane 4,4′-diisocyanate may likewise be in the form of a mixture of the different cis and trans isomers.

Aromatic isocyanates are those which comprise at least one aromatic ring system.

Cycloaliphatic isocyanates are those which comprise at least one cycloaliphatic ring system.

Aliphatic isocyanates are those which comprise exclusively linear or branched chains, in other words acyclic compounds.

For the present invention it is possible to use not only those di- and polyisocyanates obtained by phosgenating the corresponding amines but also those prepared without the use of phosgene, i.e., by phosgene-free processes. According to EP-A-0 126 299 (U.S. Pat. No. 4,596,678), EP-A-126 300 (U.S. Pat. No. 4,596,679), and EP-A-355 443 (U.S. Pat. No. 5,087,739), for example, (cyclo)aliphatic diisocyanates, such as hexamethylene 1,6-diiso-cyanate (HDI), isomeric aliphatic diisocyanates having 6 carbon atoms in the alkylene radical, 4,4′- or 2,4′-di(isocyanatocyclohexyl)methane, and 1-isocyanato-3-isocyanato-methyl-3,5,5-trimethylcyclohexane (isophorone diisocyanate or IPDI), for example, can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis takes place usually continuously in a circulation process and in the presence, if appropriate, of N-unsubstituted carbamic esters, dialkyl carbonates, and other by-products recycled from the reaction process. Di- or polyisocyanates obtained in this way generally contain a very low or even unmeasurable fraction of chlorinated compounds, leading to favorable color numbers in the products.

In one embodiment of the present invention the di- and polyisocyanates (B) have a total hydrolyzable chlorine content of less than 200 ppm, preferably of less than 120 ppm, more preferably less than 80 ppm, very preferably less than 50 ppm, in particular less than 15 ppm, and especially less than 10 ppm. This can be measured by means, for example, of ASTM specification D4663-98. Alternatively, though, di- and polyisocyanates (B) having a higher chlorine content can also be used.

Mention may further be made of
1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoiso-cyanurates and in particular to those based on hexamethylene diisocyanate and isophorone diisocyanate. The isocyanurates present are, in particular, tris-isocyanatoalkyl and/or tris-isocyanatocycloalkyl isocyanurates, which constitute cyclic trimers of the diisocyanates, or are mixtures with their higher homologues containing more than one isocyanurate ring. The isocyanatoisocyanurates generally have an NCO content of 10% to 30% by weight, in particular 15% to 25% by weight, and an average NCO functionality of 2.6 to 8.
2) Uretdione diisocyanates with aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The uretdione diisocyanates can be used as a sole component or in a mixture with other polyisocyanates, particularly those specified under 1).
3) Polyisocyanates containing biuret groups and having aromatically, cyclo-aliphatically or aliphatically attached, preferably cycloaliphatically or aliphatically attached, isocyanate groups, especially tris(6-isocyanatohexyl)biuret or its mixtures with its higher homologues. These polyisocyanates containing biuret groups generally have an NCO content of 18% to 22% by weight and an average NCO functionality of 2.8 to 4.5.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with mono- or polyhydric alcohols such as, for example, methanol, ethanol, isopropanol, n-propanol, n-butanol, isobutanol, sec-butanol, tert-butanol, n-hexanol, n-heptanol, n-octanol, n-decanol, n-dodecanol (lauryl alcohol), 2-ethylhexanol, n-pentanol, stearyl alcohol, cetyl alcohol, lauryl alcohol, ethylene glycol monomethyl ether, ethylene glycol monoethyl ether, 1,3-propane-diol monomethyl ether, cyclopentanol, cyclohexanol, cyclooctanol, cyclo-dodecanol, trimethylolpropane, neopentyl glycol, pentaerythritol, 1,4-butanediol, 1,6-hexanediol, 1,3-propanediol, 2-ethyl-1,3-propanediol, 2-methyl-1,3-propane-diol, ethylene glycol, diethylene glycol, triethylene glycol, tetraethylene glycol, pentaethylene glycol, glycerol, 1,2-dihydroxypropane, 2,2-dimethyl-1,2-ethane-diol, 1,2-butanediol, 1,4-butanediol, 3-methylpentane-1,5-diol, 2-ethylhexane-1,3-diol, 2,4-diethyloctane-1,3-diol, hydroxypivalic acid neopentyl glycol ester, ditrimethylolpropane, dipentaerythritol, 2,2-bis(4-hydroxycyclohexyl)propane, 1,1-, 1,2-, 1,3-, and 1,4-cyclohexanedimethanol, 1,2-, 1,3- or 1,4-cyclohexanediol or mixtures thereof. These polyisocyanates containing urethane and/or allophanate groups generally have an NCO content of 12% to 20% by weight and an average NCO functionality of 2.5 to 4.5.
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A1 10013186 or DE-A1 10013187.
10) Polyurethane-polyisocyanate prepolymers, from di- and/or polyisocyanates with alcohols.
11) Polyurea-polyisocyanate prepolymers.

Polyisocyanates 1) to 11) may be used in a mixture, including if appropriate in a mixture with diisocyanates.

The di- and polyisocyanates (B) may also be present at least partly in blocked form.

Groups of this kind for blocking isocyanates are described in D. A. Wicks, Z. W. Wicks, Progress in Organic Coatings, 36, 148-172 (1999), 41, 1-83 (2001) and also 43, 131-140 (2001).

This is especially preferred when the coating compositions of the invention are to be employed in one-component form.

Preferred compounds (B) are the urethanes, biurets, and isocyanurates, more preferably the isocyanurates, of hexamethylene 1,6-diisocyanate (HDI) or 1-iso-cyanato-3-isocyanatomethyl-3,5,5-trimethylcyclohexane, very preferably of 1-isocyanato-3-isocyanatomethyl-3,5,5-trimethylcyclohexane.

As a result of their preparation it is possible for polyisocyanates (B) still to have a small fraction of their parent monomeric diisocyanate; for example, up to 5%, more preferably up to 3%, very preferably up to 2%, in particular up to 1%, especially up to 0.5%, and even up to 0.25% by weight.

The coating compositions of the invention further comprise in general at least one binder (C) and also, if appropriate, further cocrosslinkers (D) and/or typical coatings additives (E) and also, if appropriate, pigments and/or fillers (F).

Preferred binders (C) are selected from the group consisting of polyetherols, polyesterols, polyacrylate polyols and melamine-formaldehyde resins, particular preference being given to polyesterols and polyacrylate polyols, and very particular preference to polyacrylate polyols.

Polyester polyols are known for example from Ullmanns Enzyklopädie der technischen Chemie, 4th Edition, Volume 19, pp. 62 to 65. Preference is given to using polyester polyols obtained by reacting dihydric alcohols with dibasic carboxylic acids. Instead of the free polycarboxylic acids it is also possible to use the corresponding polycarboxylic anhydrides or corresponding polycarboxylic esters of lower alcohols, or mixtures thereof, to prepare the polyester polyols. The polycarboxylic acids may be aliphatic, cycloaliphatic, araliphatic, aromatic or heterocyclic and may if appropriate be substituted, by halogen atoms for example, and/or unsaturated. Examples thereof that may be mentioned include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄ alkyl esters for example, preferably methyl, ethyl or n-butyl esters, of the stated acids are used. Preference is given to dicarboxylic acids of the general formula HOOC—(CH₂)_{y}—COOH, y being a number from 1 to 20, preferably an even number from 2 to 20, more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass between 162 and 2000, poly-1,2-propanediol or poly-1,3-propanediol having a molar mass between 134 and 10000, preferably 134 to 5000, and more preferably 134 to 2000, or polyethylene glycol, and also mixed polyethylene/propylene glycols as copolymers, it being possible for the 1,2-ethylene and 1,2-propylene units to be incorporated randomly or blockwise into the copolymer, having a molar mass between 106 and 10000, preferably 134 to 5000, and more preferably 134 to 2000, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,2- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (Iyxitol), xylitol, dulcitol (galactitol), maltitol, isomalt, tris(hydroxymethyl)-isocyanurate or tris(hydroxyethyl)isocyanurate (THEIC). Mixtures of the stated alcohols are of course also suitable.

Preference is given to alcohols of the general formula HO—(CH₂)ₓ—OH, x being a number from 1 to 20, preferably an even number from 2 to 20. Preferred are ethylene glycol, butane-1,4-diol, hexane-1,6-diol, octane-1,8-diol, and dodecane-1,12-diol. Additionally preferred is neopentyl glycol.

Also suitable are polycarbonate diols such as may be obtained, for example, by reacting phosgene with an excess of the low molecular mass alcohols specified as constituent components for the polyester polyols.

Also suitable are lactone-based polyester diols, which are homopolymers or copolymers of lactones, preferably hydroxyl-terminated adducts of lactones with suitable difunctional starter molecules. Suitable lactones are preferably those deriving from compounds of the general formula HO—(CH₂)_{z}—COOH, z being a number from 1 to 20 and it also being possible for a hydrogen atom of a methylene unit to be substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and also mixtures thereof. Suitable starter components are, for example, the low molecular mass dihydric alcohols specified above as a constituent component for the polyester polyols. The corresponding polymers of E-caprolactone are particularly preferred. Lower polyester diols or polyether diols can also be used as starters for preparing the lactone polymers. In lieu of the polymers of lactones it is also possible to employ the corresponding, chemically equivalent polycondensates of the hydroxycarboxylic acids that correspond to the lactones.

The polyesters preferably have a molecular weight Mₙ (number average), as determinable by gel permeation chromatography, of 500 to 50000, in particular 1000 to 10000 g/mol and a hydroxyl number of 16.5 to 264, preferably 33 to 200 mg KOH/g resin solids.

The glass transition temperature T_{g} (DSC method (Differential Scanning Calorimetry) in accordance with ASTM 3418/82) of these polyesters is preferably from −30 to 120° C.

Furthermore, polyacrylate polyols are preferred. These are generally copolymers of, substantially, (meth)acrylic esters, examples being the C₁-C₂₀ alkyl (meth)acrylates set out above in connection with the reactive diluents, with hydroxyalkyl (meth)acrylates, examples being the mono(meth)acrylic esters of 1,2-propanediol, ethylene glycol, 1,3-propanediol, 1,4-butanediol or 1,6-hexanediol.

These preferably have a molecular weight Mₙ (number average), as determinable by gel permeation chromatography, of 500 to 50000, in particular 1000 to 10000 g/mol and a hydroxyl number of 16.5 to 264, preferably 33 to 200 mg KOH/g resin solids.

The glass transition temperature T_{g} (DSC method (Differential Scanning Calorimetry) in accordance with ASTM 3418/82) of these polyacrylate polyols is preferably from −30 to 100° C.

The monomers which have hydroxyl groups are used in the copolymerization in amounts such as to result in the abovementioned hydroxyl numbers of the polymers, which correspond, moreover, in general to a hydroxyl group content for the polymers of 0.5% to 8%, preferably 1% to 5% by weight. In general the hydroxy-functional comonomers are used in amounts of 3% to 75%, preferably 6% to 47% by weight, based on the total weight of the monomers employed. Furthermore, as will be appreciated, it is necessary to ensure that within the figures given, the amount of hydroxy-functional monomers is selected so as to produce copolymers which have on average per molecule at least two hydroxyl groups.

The non-hydroxy-functional monomers include, for example, reactive diluents—that is, free-radically or cationically polymerizable compounds having only one ethylenically unsaturated, copolymerizable group.

Mention may be made, by way of example, of C₁-C₂₀ alkyl (meth)acrylates, vinylaromatics having up to 20 C atoms, vinyl esters of carboxylic acids comprising up to 20 C atoms, ethylenically unsaturated nitriles, vinyl ethers of alcohols comprising 1 to 10 C atoms, α,β-unsaturated carboxylic acids and their anhydrides, and aliphatic hydrocarbons having 2 to 8 C atoms and 1 or 2 double bonds.

Preferred (meth)acrylic acid alkyl esters are those with a C₁-C₁₀ alkyl radical, such as methyl methacrylate, methyl acrylate, n-butyl acrylate, ethyl acrylate, and 2-ethylhexyl acrylate.

In particular, mixtures of the (meth)acrylic acid alkyl esters are also suitable.

Vinyl esters of carboxylic acids having 1 to 20 C atoms are, for example, vinyl laurate, vinyl stearate, vinyl propionate, and vinyl acetate.

Possible examples of α,β-unsaturated carboxylic acids and their anhydrides include acrylic acid, methacrylic acid, fumaric acid, crotonic acid, itaconic acid, maleic acid, and maleic anhydride, preferably acrylic acid.

Examples of suitable vinylaromatic compounds include vinyltoluene, α-butylstyrene, 4-n-butylstyrene, 4-n-decylstryene, and—preferably—stryene.

Examples of nitriles are acrylonitrile and methacrylonitrile.

Suitable vinyl ethers are, for example, vinyl methyl ether, vinyl isobutyl ether, vinyl hexyl ether, and vinyl octyl ether.

As nonaromatic hydrocarbons having 2 to 8 C atoms and one or two or olefinic double bonds, mention may be made of butadiene, isoprene, and also ethylene, propylene, and isobutylene.

In addition it is possible to employ N-vinylformamide, N-vinylpyrrolidone, and N-vinylcaprolactam.

Preference is given to esters of acrylic acid or of methacrylic acid having 1 to 18, preferably 1 to 8, carbon atoms in the alcohol residue, such as methyl acrylate, ethyl acrylate, isopropyl acrylate, n-propyl acrylate, n-butyl acrylate, 2-ethylhexyl acrylate, n-stearyl acrylate, the methacrylates corresponding to these acrylates, styrene, alkyl-substituted styrenes, acrylonitrile, methacrylonitrile, vinyl acetate or vinyl stearate, or any desired mixtures of such monomers. Comonomers containing epoxide groups, as well, such as glycidyl acrylate or methacrylate, or monomers such as N-methoxy-methylacrylamide or N-methoxymethylmethacrylamide, can be used in small amounts.

The polymers can be prepared by polymerization in accordance with customary methods. Preferably the polymers are prepared in organic solution. Continuous or discontinuous polymerization methods are possible. Of the discontinuous methods, mention may be made of the batch method and the feed method, the latter being preferred. With the feed method the solvent is introduced as an initial charge, on its own or together with a fraction of the monomer mixture, this initial charge is heated to the polymerization temperature, the polymerization is initiated free-radically in the case of an initial monomer charge, and the remaining monomer mixture is metered in together with an initiator mixture over the course of 1 to 10 hours, preferably 3 to 6 hours. If appropriate, activation is performed again subsequently in order to take the polymerization to a conversion of at least 99%.

Suitable solvents include, for example, aromatics, such as solvent naphtha, benzene, toluene, xylene, chlorobenzene, esters such as ethyl acetate, butyl acetate, methyl glycol acetate, ethyl glycol acetate, methoxypropyl acetate, ethers such as butyl glycol, tetrahydrofuran, dioxane, ethyl glycol ether, ketones such as acetone, methyl ethyl ketone, halogenated solvents such as methylene chloride or trichloromonofluoroethane.

Preferred polyetherols are alkoxylated diols or polyols, more preferably the diols or polyols recited below, in alkoxylated form:

diols are, for example, ethylene glycol, 1,2-propanediol, 1,3-propanediol, 1,1-dimethyl-ethane-1,2-diol, 2-butyl-2-ethyl-1,3-propanediol, 2-ethyl-1,3-propanediol, 2-methyl-1,3-propanediol, neopentyl glycol, neopentyl glycol hydroxypivalate, 1,2-, 1,3- or 1,4-butanediol, 1,6-hexanediol, 1,10-decanediol, bis(4-hydroxycyclohexane)-isopropylidene, tetramethylcyclobutanediol, 1,2-, 1,3- or 1,4-cyclohexanediol, cyclooctanediol, norbornanediol, pinanediol, decalindiol, 2-ethyl-1,3-hexanediol, 2,4-diethyloctane-1,3-diol, hydroquinone, bisphenol A, bisphenol F, bisphenol B, bisphenol S, 2,2-bis(4-hydroxycyclohexyl)propane, 1,1-, 1,2-, 1,3- and 1,4-cyclo-hexanedimethanol, 1,2-, 1,3- or 1,4-cyclohexanediol.

Polyols are for example the above-recited polyesterols, trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (Iyxitol), xylitol, dulcitol (galactitol), maltitol or isomalt.

The compounds in question are preferably singly to pentuply, more preferably triply to pentuply, and very preferably quadruply, ethoxylated, propoxylated or mixedly ethoxylated and propoxylated and, in particular, exclusively ethoxylated glycerol, neopentyl glycol, trimethylolpropane, trimethylolethane or pentaerythritol.

Examples of possible epoxidized olefins suitable for the alkoxylation include ethylene oxide, propylene oxide, isobutylene oxide, 1-butene oxide, 2-butene oxide, vinyl-oxirane, styrene oxide and/or epichlorohydrin; preference is given to ethylene oxide, propylene oxide, isobutylene oxide, vinyloxirane, styrene oxide or epichlorohydrin, particular preference to ethylene oxide and propylene oxide, and very particular preference to ethylene oxide.

In the case of alkoxylates the compounds may be random or block copolymers.

Further examples of polyetherols are poly THF having a molar mass between 162 and 2000, preferably between 162 and 1458, more preferably between 162 and 1098, very preferably between 162 and 738 and in particular between 162 and 378, poly-1,3-propanediol and poly-1,2-propanediol having a molar mass between 134 and 1178, preferably between 134 and 888, more preferably between 134 and 598 and very preferably between 134 and 308, polyethylene glycol having a molar mass between 106 and 898, preferably between 106 and 458, more preferably from 106 to 400, very preferably between 106 and 235 and especially diethylene glycol, triethylene glycol and tetraethylene glycol.

Further suitable binders include melamine-formaldehyde resins. Reactive groups of this kind include active methylol or alkylalkoxy groups, especially methylalkoxy groups, and also, if appropriate, imino groups (—NH—) on amino resin crosslinkers, such as etherified reaction products of formaldehyde with amines, such as melamine, urea, etc., phenol/formaldehyde adducts, siloxane or silane groups, and anhydrides, as described for example in U.S. Pat. No. 5,770,650.

Among the preferred amino resins, which are known and widespread in the art, those which can be used with particular preference include urea resins and melamine resins, such as urea-formaldehyde resins, melamine-formaldehyde resins, melamine-phenol-formaldehyde resins or melamine-urea-formaldehyde resins.

Suitable urea resins are those which are obtainable by reacting ureas with aldehydes and which if appropriate may be modified.

Suitable ureas are urea, N-substituted or N,N′-disubstituted ureas, such as N-methylurea, N-phenylurea, N,N′-dimethylurea, hexamethylenediurea, N,N′-diphenylurea, 1,2-ethylenediurea, 1,3-propylenediurea, diethylenetriurea, dipropylenetriurea, 2-hydroxypropylenediurea, 2-imidazolidinone (ethyleneurea), 2-oxohexahydropyrimidine (propyleneurea) or 2-oxo-5-hydroxyhexahydropyrimidine (5-hydroxypropyleneurea).

Particularly suitable aldehydes include formaldehyde, acetaldehyde, isobutyraldehyde, and glyoxal.

Urea resins may if appropriate be partly or fully modified, by reaction for example with monofunctional or polyfunctional alcohols, ammonia and/or amines (cationically modified urea resins) or with (hydrogen)sulfites (anionically modified urea resins); particularly suitable in accordance with the invention are the alcohol-modified urea resins.

Suitable alcohols for the modification include C₁-C₆ alcohols, preferably C₁-C₄ alkanols, and in particular methanol, ethanol, isopropanol, n-propanol, n-butanol, isobutanol, and sec-butanol.

Suitable melamine resins are those which are obtainable by reacting melamine with aldehydes and which if appropriate may be partly or fully modified.

Melamine-formaldehyde resins are reaction products from the reaction of melamine with aldehydes, examples being the aldehydes referred to above, especially formaldehyde. If appropriate the methylol groups obtained are modified by etherification with the abovementioned monohydric or polyhydric alcohols. Additionally it is also possible for the melamine-formaldehyde resins, as described above, to be modified by reaction with amines, aminocarboxylic acids or sulfites.

The action of formaldehyde on mixtures of melamine and urea or on mixtures of melamine and phenol produces melamine-urea-formaldehyde resins or melamine-phenol-formaldehyde resins, respectively, which can likewise be used in accordance with the invention.

The stated amino resins are prepared by methods which are known per se.

Particularly specified examples are melamine-formaldehyde resins, including monomeric or polymeric melamine resins and partly or fully alkylated melamine resins, urea resins, examples being methylolureas such as formaldehyde-urea resins, alkoxyureas such as butylated formaldehyde-urea resins, and also N-methylolacrylamide emulsions, isobutoxymethylacrylamide emulsions, polyanhydrides, such as polysuccinic anhydride, and siloxanes or silanes, such as dimethyldimethoxysilanes, for example.

Particular preference is given to amino resins such as melamine-formaldehyde resins or formaldehyde-urea resins.

Typical melamine-formaldehyde resins have solids contents of 50% to 97%, preferably of 60% to 96%, and more preferably 70% to 95%.

These melamine-formaldehyde resins are frequently in solution in methanol, ethanol, n-butanol, isobutanol, xylene, butyl glycol and/or water.

The viscosities at 23° C. are up to 10 Pas, preferably up to 7, more preferably up to 6 Pas. Viscosities rarely go below 0.5 Pas.

The number-average molecular weight Mn is generally 250 to 1300, preferably 300 to 1000, and more preferably 300 to 450. The weight-average molecular weight is generally 400 to 4200, preferably 400 to 1700, and more preferably 450 to 700.

The OH number to DIN 53240-2 is generally 40 to 1200 mg KOH/g.

The molar ratio of incorporation of melamine to formaldehyde to alcohol is generally 1:2-6:1-6, preferably 1:3-6:2-6, and more preferably 1:4-6:3-5.5.

Cocrosslinkers (D) are other compounds than the di- and polyisocyanate (B), which are able to react with the binders (C) employed.

Preferred cocrosslinkers (D) are compounds containing carbamate groups, which are employed in particular with preference when at least one melamine-formaldehyde resin is used as binder.

Particularly preferred compounds containing carbamate groups are tris(alkylcarbamoyl)triazines of the formula (VII)

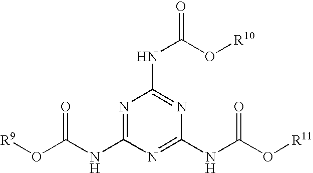

in which
R⁹, R¹⁰, and R¹¹ each independently are C₁-C₁₈ alkyl, preferably C₁-C₄ alkyl, and more preferably methyl and/or n-butyl.

Further, typical coatings additives (E) which may be used include for example antioxidants, stabilizers, activators (accelerants), antistats, flame retardants, thickeners, thixotropic agents, surface-active agents, viscosity modifiers plasticizers or chelating agents.

Suitable thickeners include not only free-radically (co)polymerized (co)polymers but also customary organic and inorganic thickeners such as hydroxymethylcellulose or bentonite.

As chelating agents it is possible, for example, to use ethylenediamineacetic acid and its salts, and also β-diketones.

Suitable fillers comprise silicates, examples being silicates obtainable by hydrolysis of silicon tetrachloride, such as Aerosil® from Degussa, silicious earth, talc, aluminum silicates, magnesium silicates, and calcium carbonates, etc.

Suitable stabilizers comprise typical UV absorbers such as oxanilides, triazines, and benzotriazole (the latter obtainable as Tinuvin® grades from Ciba-Spezialitätenchemie), and benzophenones. They can be employed alone or together with suitable free-radical scavengers, examples being sterically hindered amines such as 2,2,6,6-tetramethylpiperidine, 2,6-di-tert-butylpiperidine or derivatives thereof, e.g., bis(2,2,6,6-tetramethyl-4-piperidyl) sebacate. Stabilizers are used usually in amounts of 0.1% to 5.0% by weight, based on the solid components comprised in the preparation.

The additives (E), where they are solids, preferably have a particle size below 100 μm and more preferably below 50 μm.

In one particular embodiment the additives (E), where they are solids, preferably have a particle size of 1 to 1000 nm, more preferably 1 to 100 nm, very preferably 5 to 50 nm, and in particular 5 to 25 nm.

Particles of this kind may be constituted such as described in EP 1204701 B1, paragraph [0032] to [0059], which is hereby part of the disclosure content of this specification.

The distribution of the particles within the finished coating may be uniform or nonuniform. In the case of a nonuniform distribution the particles are preferably at a higher concentration at the surface of the coating than within the coating.

The coating compositions may further comprise pigments, dyes and/or fillers (F).

Pigments, according to CD Römpp Chemie Lexikon—Version 1.0, Stuttgart/New York: Georg Thieme Verlag 1995, with reference to DIN 55943, are particulate, “organic or inorganic, chromatic or achromatic colorants which are virtually insoluble in the application medium”. Pigments differ in this respect from soluble dyes.

Virtually insoluble here means a solubility at 25° C. of below 1 g/1000 g of application medium, preferably below 0.5 g, more preferably below 0.25 g, very preferably below 0.1 g, and in particular below 0.05 g/1000 g of application medium.

Examples of pigments comprise any desired systems of absorption pigments and/or effect pigments, preferably absorption pigments. There are no restrictions whatsoever governing the number and selection of the pigment components. They can be adapted as desired to the particular requirements, such as the desired color impression, for example.

By effect pigments are meant all pigments which exhibit a platelet-shaped construction and impart specific decorative color effects to a surface coating. The effect pigments comprise, for example, all of the effect-imparting pigments which can be employed commonly in vehicle finishing and industrial coating. Examples of effect pigments of this kind are pure metal pigments, such as aluminum, iron or copper pigments; interference pigments, such as titanium dioxide-coated mica, iron oxide-coated mica, mixed oxide-coated mica (e.g., with titanium dioxide and Fe₂O₃ or titanium dioxide and Cr₂O₃), metal oxide-coated aluminum, or liquid-crystal pigments.

The color-imparting absorption pigments are, for example, customary organic or inorganic absorption pigments which can be used in the coatings industry. Examples of organic absorption pigments are azo pigments, phthalocyanine pigments, quinacridone pigments, and pyrrolopyrrole pigments. Examples of inorganic absorption pigments are iron oxide pigments and carbon black.

A further pigment for mention is titanium dioxide.

Examples of pigments are listed in WO 97/08255, p. 8, I. 11 to p. 11, I. 16, which is hereby part of the disclosure content of this specification.

The constitution of the coating composition of the invention is typically as follows:

(A) from 0.1% to 80%, preferably from 10% to 80% by weight,
(B) from 0.1% to 80%, preferably from 10% to 80% by weight,
(C) from 0% to 99%, preferably from 0% to 80% by weight,
(D) from 0% to 50%, preferably from 0% to 30% by weight,
(E) from 0% to 5%, preferably from 0.1% to 5% by weight,
(F) from 0% to 60%, preferably from 0.1% to 40% by weight,
with the proviso that the sum always adds up to 100% by weight.

The molar ratio of nonblocked or blocked isocyanate groups in (B) to isocyanate-reactive groups in (A) and (C) in total amounts in general to 0.5:1 to 2:1, preferably 0.8:1 to 1.2:1, more preferably 0.9:1 to 1.1:1, and very preferably 0.95:1 to 1.05:1.

The coating compositions of the invention may be either one-component or two-component. Two-component means here that components (A) and (B), and any other film-forming constituents, are mixed with one another not until a relatively short time prior to application, and then react with one another essentially only after application to the substrate. With two-component coating materials, mixing takes place usually within a period of not more than 12 hours, preferably not more than 10 hours, more preferably not more than 9 hours, very preferably not more than 7 hours, in particular not more than 5 hours, and especially not more than 3 hours prior to application to the substrate.

In contrast to these, one-component (1K) coating compositions can be mixed with one another a relatively long time prior to application.

The coatings obtained with the coating compositions of the invention have a glass transition temperature, T_{g}, of generally above −30° C., preferably above −10° C. The upper limit is situated generally at glass transition temperatures T_{g} of not more than 120° C., preferably not more than 100° C. (by the DSC (differential scanning calorimetry) method in accordance with ASTM 3418/82).

In one further embodiment of the present invention the coating compositions of the invention have dual-cure or multi-cure capacity.

The term “dual cure” or “multi cure” refers in the context of this specification to a curing operation which takes place by way of two or more than two mechanisms, respectively, selected for example from radiation curing, moisture curing, chemical curing, oxidative curing and/or thermal curing, preferably from radiation curing, moisture curing, chemical curing and/or thermal curing, more preferably from radiation curing, chemical curing and/or thermal curing, and very preferably radiation curing and chemical curing.

Radiation curing in the sense of this specification is defined as the polymerization of polymerizable compounds consequent upon electromagnetic and/or particulate radiation, preferably UV light in the wavelength range of λ=200 to 700 nm and/or electron beams in the range from 150 to 300 keV, and with particular preference with a radiation dose of at least 80, preferably 80 to 3000 mJ/cm².

In order to induce radiation curing it is possible for the coating compositions of the invention to be admixed preferably with free-radically polymerizable compounds, examples being those selected from the group consisting of polyetherol(meth)acrylates, polyesterol(meth)acrylates, epoxy(meth)acrylates, urethane(meth)acrylates, and polycarbonate(meth)acrylates, and also if appropriate, as reactive diluents, polyfunctional (meth)acrylates of low viscosity which carry at least 1, preferably 2-10, more preferably 2-6, very preferably 2-4, and in particular 2-3 (meth)acrylate groups, preferably acrylate groups.

The present invention further provides reaction products (G) of compounds (A) which have at least one, preferably at least two isocyanate-reactive groups (Y), with at least one isocyanate compound containing at least one, preferably at least two, isocyanate group(s).

Isocyanates of this kind may be monomers or oligomers of aromatic, aliphatic or cycloaliphatic diisocyanates, preferably of aliphatic or cycloaliphatic diisocyanates, or polyisocyanates based on these diisocyanates.

The NCO functionality of such a compound is generally at least 1.8 and can be up to 8, preferably 1.8 to 5, and more preferably 2 to 4.

Suitable polyisocyanates include polyisocyanates containing isocyanurate groups, polyisocyanates containing uretdione groups, polyisocyanates containing biuret groups, polyisocyanates containing urethane groups or allophanate groups, polyisocyanates comprising oxadiazinetrione groups or iminooxadiazinedione groups, uretonimine-modified polyisocyanates, synthesized from linear or branched C₄-C₂₀ alkylene diisocyanates, cycloaliphatic diisocyanates having a total of 6 to 20 carbon atoms or aromatic diisocyanates having a total of 8 to 20 carbon atoms, or mixtures thereof.

Preference is given to polyisocyanates containing isocyanurate, urethane or allophanate groups.

The diisocyanates are preferably isocyanates having 4 to 20 carbon atoms. Examples of typical diisocyanates are aliphatic diisocyanates such as tetramethylene diisocyanate, hexamethylene diisocyanate (1,6-diisocyanatohexane), octamethylene diisocyanate, decamethylene diisocyanate, dodecamethylene diisocyanate, tetradeca-methylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)-methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4-, or 2,6-diiso-cyanato-1-methylcyclohexane, and also 3 (or 4), 8 (or 9)-bis(isocyanatomethyl)tricyclo-[5.2.1.0²⁶]decane isomer mixtures, and also aromatic diisocyanates such as tolylene 2,4- or 2,6-diisocyanate and the isomer mixtures thereof, m- or p-xylylene diisocyanate, 2,4′- or 4,4′-diisocyanatodiphenylmethane and the isomer mixtures thereof, phenylene 1,3- or 1,4-diisocyanate, 1-chlorophenylene 2,4-diisocyanate, naphthylene 1,5-diiso-cyanate, diphenylene 4,4′-diisocyanate, 4,4′-diisocyanato-3,3′-dimethylbiphenyl, 3-methyldiphenylmethane 4,4′-diisocyanate, tetramethylxylylene diisocyanate, 1,4-diisocyanatobenzene or diphenyl ether 4,4′-diisocyanate. Mixtures of said diisocyanates may also be present.

Also suitable are higher isocyanates, having on average more than 2 isocyanate groups. Examples include triisocyanates such as triisocyanatononane, 2,4,6-triiso-cyanatotoluene, triphenylmethane triisocyanate or 2,4,4′-triisocyanatodiphenyl ether, or the mixtures of diisocyanates, triisocyanates, and higher polyisocyanates, for example that are obtained by phosgenating corresponding aniline/formaldehyde condensates and represent polyphenyl polyisocyanates containing methylene bridges.

The di- and polyisocyanates which can be used preferably have an isocyanate group (calculated as NCO, molecular weight =42) content of 10% to 60% by weight, based on the di- and polyisocyanate (mixture), preferably 15% to 60% by weight, and more preferably 20% to 55% by weight.

Preference is given to aliphatic and/or cycloaliphatic di- and polyisocyanates, examples being the aliphatic and/or cycloaliphatic diisocyanates stated above, or mixtures thereof.

Particular preference is given to hexamethylene diisocyanate, 1,3-bis-(isocyanatomethyl)cyclohexane, isophorone diisocyanate, and 4,4′- or 2,4′-di-(isocyanatocyclohexyl)methane, very particular preference to isophorone diisocyanate and hexamethylene diisocyanate, and especial preference to hexamethylene diisocyanate.

Isophorone diisocyanate is usually in the form of a mixture, specifically a mixture of the cis and trans isomers, generally in a proportion of about 60:40 to 80:20 (w/w), preferably in a proportion of about 70:30 to 75:25, and more preferably in a proportion of approximately 75:25.

Dicyclohexylmethane 4,4′-diisocyanate may likewise be in the form of a mixture of the different cis and trans isomers.

Aromatic isocyanates are those which comprise at least one aromatic ring system.

Cycloaliphatic isocyanates are those which comprise at least one cycloaliphatic ring system.

Aliphatic isocyanates are those which comprise exclusively linear or branched chains, in other words acyclic compounds.

Mention may further be made of
1) Polyisocyanates containing isocyanurate groups and derived from aromatic, aliphatic and/or cycloaliphatic diisocyanates. Particular preference is given in this context to the corresponding aliphatic and/or cycloaliphatic isocyanatoiso-cyanurates and in particular to those based on hexamethylene diisocyanate and isophorone diisocyanate. The isocyanurates present are, in particular, tris-isocyanatoalkyl and/or tris-isocyanatocycloalkyl isocyanurates, which constitute cyclic trimers of the diisocyanates, or are mixtures with their higher homologues containing more than one isocyanurate ring. The isocyanatoisocyanurates generally have an NCO content of 10% to 30% by weight, in particular 15% to 25% by weight, and an average NCO functionality of 2.6 to 8.
2) Uretdione diisocyanates with aromatically, aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The uretdione diisocyanates can be used as a sole component or in a mixture with other polyisocyanates, particularly those specified under 1).
3) Polyisocyanates containing biuret groups and having aromatically, cyclo-aliphatically or aliphatically attached, preferably cycloaliphatically or aliphatically attached, isocyanate groups, especially tris(6-isocyanatohexyl)biuret or its mixtures with its higher homologues. These polyisocyanates containing biuret groups generally have an NCO content of 18% to 22% by weight and an average NCO functionality of 2.8 to 4.5.
4) Polyisocyanates containing urethane and/or allophanate groups and having aromatically, aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with mono- or polyhydric alcohols such as, for example, methanol, ethanol, isopropanol, n-propanol, n-butanol, isobutanol, sec-butanol, tert-butanol, n-hexanol, n-heptanol, n-octanol, n-decanol, n-dodecanol (lauryl alcohol), 2-ethylhexanol, n-pentanol, stearyl alcohol, cetyl alcohol, lauryl alcohol, ethylene glycol monomethyl ether, ethylene glycol monoethyl ether, 1,3-propane-diol monomethyl ether, cyclopentanol, cyclohexanol, cyclooctanol, cyclo-dodecanol, trimethylolpropane, neopentyl glycol, pentaerythritol, 1,4-butanediol, 1,6-hexanediol, 1,3-propanediol, 2-ethyl-1,3-propanediol, 2-methyl-1,3-propane-diol, ethylene glycol, diethylene glycol, triethylene glycol, tetraethylene glycol, pentaethylene glycol, glycerol, 1,2-dihydroxypropane, 2,2-dimethyl-1,2-ethane-diol, 1,2-butanediol, 1,4-butanediol, 3-methylpentane-1,5-diol, 2-ethylhexane-1,3-diol, 2,4-diethyloctane-1,3-diol, hydroxypivalic acid neopentyl glycol ester, ditrimethylolpropane, dipentaerythritol, 2,2-bis(4-hydroxycyclohexyl)propane, 1,1-, 1,2-, 1,3-, and 1,4-cyclohexanedimethanol, 1,2-, 1,3- or 1,4-cyclohexanediol or mixtures thereof. These polyisocyanates containing urethane and/or allophanate groups generally have an NCO content of 12% to 20% by weight and an average NCO functionality of 2.5 to 4.5.

In one preferred embodiment the alcohols are those having a hydroxyl and at least one (meth)acrylate group, such as 2-hydroxethyl acrylate, 2-hydroxyethyl methacrylate, 2-hydroxypropyl acrylate, 2-hydroxypropyl methacrylate or pentaerythintol triacylate. More preferably the compounds are polyisocyanates with allophanate groups, as described in WO 00/39183, particularily from p. 4 I.14 to p. 11 I.1 therein, and also the compounds disclosed in the examples; this is hereby part of the disclosure content of the present text.
5) Polyisocyanates comprising oxadiazinetrione groups, derived preferably from hexamethylene diisocyanate or isophorone diisocyanate. Polyisocyanates of this kind comprising oxadiazinetrione groups are accessible from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A1 10013186 or DE-A1 10013187.
10) Polyurethane-polyisocyanate prepolymers, from di- and/or polyisocyanates with alcohols.
11) Polyurea-polyisocyanate prepolymers.

Polyisocyanates 1) to 11) may be used in a mixture, including if appropriate in a mixture with diisocyanates.

Preferred compounds (G) are those of the following formulae

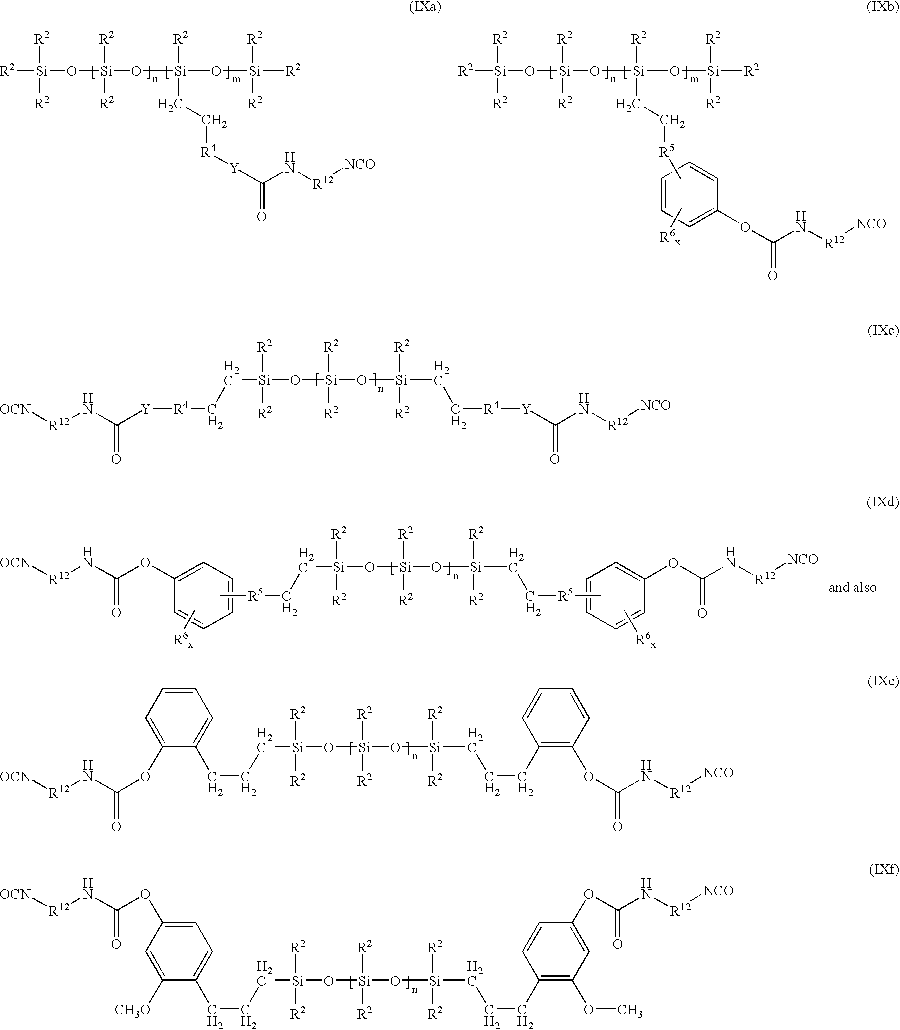

in which the radicals are as defined above and additionally

R¹² is a divalent aromatic, aliphatic or cycloaliphatic organic radical comprising 2 to 20 carbon atoms.

Preferred radicals R¹² are 1,6-hexylene, 2,4-tolylene, 2,6-tolylene, isophorylene, 4,4′-bis(cyclohexyl)methanylene; particular preference is given to 1,6-hexylene.

Particularly preferred compounds are those of the formula (IXg)

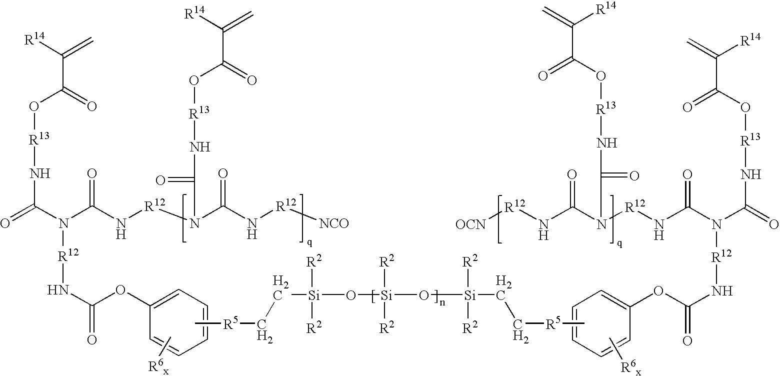

in which
the radicals are as defined above and additionally
R¹³ is a divalent aliphatic or cycloaliphatic radical having 1 to 8 carbon atoms,
R¹⁴ is hydrogen or methyl, and
q is a positive integral or on average fractional real number of at least 1.

Examples of R¹³ are 1,2-ethylene, 1,2-propylene, 1,3-propylene, 1,1-dimethyl-1,2-ethylene, 1,4-butylene and 1,6-hexylene, preference being given to 1,2-ethylene, 1,2-propylene, 1,3-propylene, and particular preference to 1,2-ethylene.

R¹⁴ is preferably hydrogen.

The value for q is preferably more than 1, more preferably more than 1 to 10, very preferably more than 1 to 5, in particular more than 1 to 3, and especially more than 1 to 2.

The present invention further provides reaction products (H) of the above-described compounds (G) with compounds which have at least one, preferably precisely one, isocyanate-reactive group and at least one, preferably 1 to 6, more preferably 1 to 4, very preferably 1 to 3 free-radically polymerizable group(s).

Isocyanate-reactive groups may be, for example, —OH, —SH, —NH₂, and —NHR¹⁵, where R¹⁵ is hydrogen or an alkyl group comprising 1 to 4 carbon atoms, such as methyl, ethyl, n-propyl, isopropyl, n-butyl, isobutyl, sec-butyl or tert-butyl, for example. Preferably the isocyanate-reactive group is hydroxyl (—OH) or amino (—NH₂), more preferably hydroxyl (—OH).

Free-radically polymerizable groups are, for example, vinyl ether groups, acrylate groups or methacrylate groups, preferably acrylate or methacrylate groups, and more preferably acrylate groups.

These may be, for example, monoesters of α,β-unsaturated carboxylic acids, such as acrylic acid, methacrylic acid, crotonic acid, itaconic acid, fumaric acid, maleic acid, acrylamidoglycolic acid, methacrylamidoglycolic acid, or vinyl ethers with diols or polyols which have preferably 2 to 20 carbon atoms and at least two hydroxyl groups, such as ethylene glycol, diethylene glycol, triethylene glycol, 1,2-propylene glycol, 1,3-propylene glycol, 1,1-dimethyl-1,2-ethanediol, dipropylene glycol, triethylene glycol, tetraethylene glycol, pentaethylene glycol, tripropylene glycol, 1,2-, 1,3- or 1,4-butanediol, 1,5-pentanediol, neopentyl glycol, 1,6-hexanediol, 2-methyl-1,5-pentanediol, 2-ethyl-1,4-butanediol, 1,4-dimethylolcyclohexane, 2,2-bis(4-hydroxycyclohexyl)propane, glycerol, trimethylolethane, trimethylolpropane, trimethylolbutane, pentaerythritol, ditrimethylolpropane, erythritol, sorbitol, poly THF having a molar weight between 162 and 2000, poly-1,3-propanediol having a molar weight between 134 and 400 or polyethylene glycol having a molar weight between 238 and 458. It is additionally possible to use esters or amides of (meth)acrylic acid with amino alcohols, examples being 2-aminoethanol, 2-(methylamino)ethanol, 3-amino-1-propanol, 1-amino-2-propanol or 2-(2-aminoethoxy)ethanol, 2-mercaptoethanol or polyaminoalkanes, such as ethylenediamine or diethylenetriamine, or vinylacetic acid.

Preference is given to using 2-hydroxyethyl (meth)acrylate, 2- or 3-hydroxypropyl (meth)acrylate, 1,4-butanediol mono(meth)acrylate, neopentyl glycol mono(meth)acrylate, 1,5-pentanediol mono(meth)acrylate, 1,6-hexanediol mono(meth)acrylate, glycerol mono- and di(meth)acrylate, trimethylolpropane mono- and di(meth)acrylate, pentaerythritol mono-, di-, and tri(meth)acrylate, and 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl(meth)acrylamide, 2-aminopropyl(meth)acrylamide, 3-aminopropyl(meth)acrylamide, 2-hydroxyethyl-(meth)acrylamide, 2-hydroxypropyl(meth)acrylamide or 3-hydroxypropyl(meth)-acrylamide. Particular preference is given to 2-hydroxyethyl acrylate, 2-hydroxyethyl methacrylate, 2- or 3-hydroxypropyl acrylate, 1,4-butanediol monoacrylate, 3-(acryloyloxy)-2-hydroxypropyl (meth)acrylate, and the monoacrylates of polyethylene glycol with a molar mass of 106 to 238.

Very particular preference is given to 2-hydroxyethyl acrylate, 2-hydroxyethyl methacrylate, 2- or 3-hydroxypropyl acrylate, 1,4-butanediol monoacrylate, and pentaerythritol triacrylate.

Preferred compounds (H) are those of the following formulae

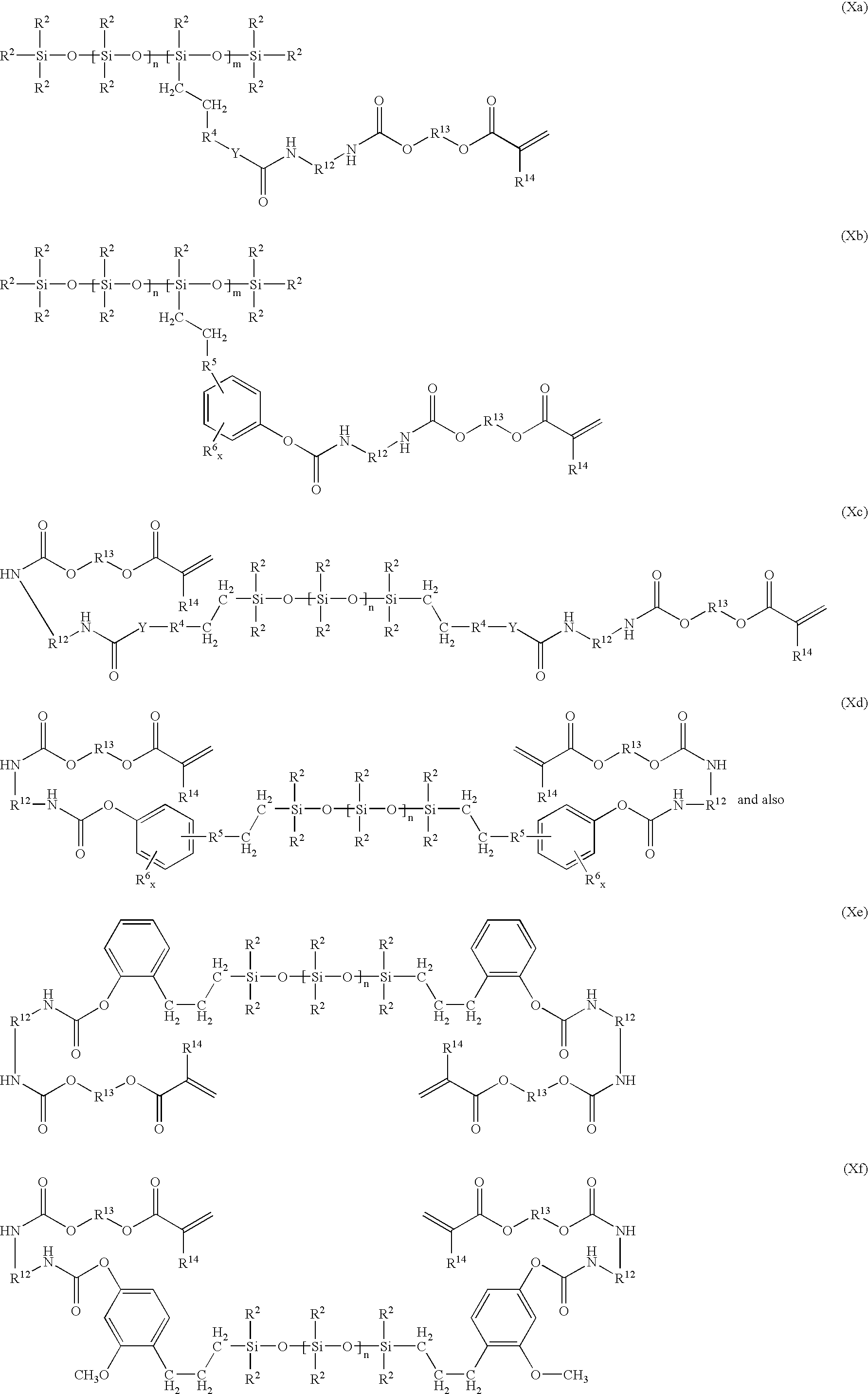

in which the radicals are as defined above and additionally
R¹² is a divalent aromatic, aliphatic or cycloaliphatic organic radical comprising 2 to 20 carbon atoms.

Preferred radicals R¹² are 1,6-hexylene, 2,4-tolylene, 2,6-tolylene, isophorylene, 4,4′-bis(cyclohexyl)methanylene; particular preference is given to 1,6-hexylene.

Particularly preferred compounds are those of the formula (Xg)

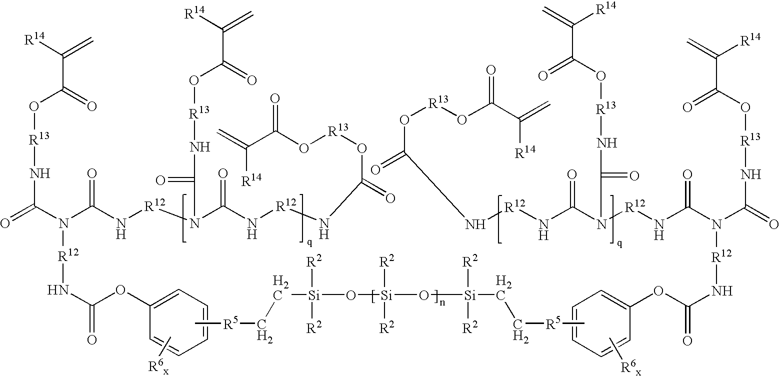

in which
the radicals are as defined above.

The present invention further provides for the use of the compounds (G) in one- or two-component polyurethane coating materials.

For use in one-component polyurethane coating materials it may be rational to block the isocyanate groups, using, for example, blocking agents of the kind described above, preferably as described in D. A. Wicks, Z. W. Wicks, Progress in Organic Coatings, 36, 148-172 (1999), 41, 1-83 (2001) and also 43, 131-140 (2001).

The present invention additionally provides for the use of the compounds (H) in radiation curing and in radiation-curable coating materials.

Compounds which have not only isocyanate groups but also free-radically polymerizable groups, such as compound (IXg), for example, can be used with advantage in dual-cure curing.

The present invention further provides radiation-curable coating compositions comprising
at least one compound (H),
if appropriate, at least one compound having one or more than one free-radically polymerizable double bond,
if appropriate, at least one photoinitiator, and
if appropriate, further, typical coatings additives.

The compounds (H) of the invention can be used as sole binder or, preferably, in combination with at least one further free-radically polymerizable compound.

Compounds having one or more than one free-radically polymerizable double bond are, for example, compounds having 1 to 6, preferably 1 to 4, and more preferably 1 to 3 free-radically polymerizable groups.

Examples of free-radically polymerizable groups include vinyl ether or (meth)acrylate groups, preferably (meth)acrylate groups, and more preferably acrylate groups.

Free-radically polymerizable compounds are frequently subdivided into monofunctional polymerizable compounds (compounds having one free-radically polymerizable double bond) and multifunctional polymerizable compounds (compounds having more than one free-radically polymerizable double bond).

Monofunctional polymerizable compounds are those having precisely one free-radically polymerizable group; multifunctional polymerizable compounds are those having more than one, preferably at least two, free-radically polymerizable groups.

Examples of monofunctional polymerizable compounds are esters of (meth)acrylic acid with alcohols having 1 to 20 carbon atoms, examples being methyl (meth)acrylate, ethyl (meth)acrylate, butyl (meth)acrylate, 2-ethylhexyl (meth)acrylate, 2-hydroxyethyl (meth)acrylate, 2-hydroxypropyl (meth)acrylate, 4-hydroxybutyl (meth)acrylate, dihydrodicyclopentadienyl acrylate, vinylaromatic compounds, e.g., styrene, divinylbenzene, α,β-unsaturated nitriles, e.g., acrylonitrile, methacrylonitrile, α,β-unsaturated aldehydes, e.g., acrolein, methacrolein, vinyl esters, e.g., vinyl acetate, vinyl propionate, halogenated ethylenically unsaturated compounds, e.g., vinyl chloride, vinylidene chloride, conjugated unsaturated compounds, e.g., butadiene, isoprene, chloroprene, monounsaturated compounds, e.g., ethylene, propylene, 1-butene, 2-butene, isobutene, cyclic monounsaturated compounds, e.g. cyclopentene, cyclohexene, cyclododecene, N-vinylformamide, allylacetic acid, vinylacetic acid, monoethylenically unsaturated carboxylic acids having 3 to 8 carbon atoms and their water-soluble alkali metal, alkaline earth metal or ammonium salts, for example: acrylic acid, methacrylic acid, dimethylacrylic acid, ethacrylic acid, maleic acid, citraconic acid, methylenemalonic acid, crotonic acid, fumaric acid, mesaconic acid, and itaconic acid, maleic acid, N-vinylpyrrolidone, N-vinyl lactams, such as N-vinylcaprolactam, N-vinyl-N-alkylcarboxamides or N-vinylcarboxamides, such as N-vinylacetamide, N-vinyl-N-methylformamide, and N-vinyl-N-methylacetamide, or vinyl ethers, examples being methyl vinyl ether, ethyl vinyl ether, n-propyl vinyl ether, isopropyl vinyl ether, n-butyl vinyl ether, sec-butyl vinyl ether, isobutyl vinyl ether, tert-butyl vinyl ether, 4-hydroxybutyl vinyl ether, and mixtures thereof.

Preference among these is given to the esters of (meth)acrylic acid, more preferably methyl (meth)acrylate, ethyl (meth)acrylate, n-butyl (meth)acrylate, 2-ethylhexyl (meth)acrylate, and 2-hydroxyethyl acrylate, very preferably n-butyl (meth)acrylate, 2-ethylhexyl (meth)acrylate, and 2-hydroxyethyl acrylate, and especially 2-hydroxyethyl acrylate.

(Meth)acrylic acid stands in this specification for methacrylic acid and acrylic acid, preferably for acrylic acid.

Multifunctional polymerizable compounds are preferably multifunctional (meth)acrylates which carry more than one, preferably 2-10, more preferably 2-6, very preferably 2-4, and in particular 2-3 (meth)acrylate groups, preferably acrylate groups.

These may be, for example, esters of (meth)acrylic acid with polyalcohols which, correspondingly, are at least dihydric.

Examples of polyalcohols of this kind are at least dihydric polyols, polyetherols or polyesterols or polyacrylate polyols having an average OH functionality of at least 2, preferably 3 to 10.

Examples of multifunctional polymerizable compounds are ethylene glycol diacrylate, 1,2-propanediol diacrylate, 1,3-propanediol diacrylate, 1,4-butanediol diacrylate, 1,3-butanediol diacrylate, 1,5-pentanediol diacrylate, 1,6-hexanediol diacrylate, 1,8-octanediol diacrylate, neopentyl glycol diacrylate, 1,1-, 1,2-, 1,3-, and 1,4-cyclohexanedimethanol diacrylate, 1,2-, 1,3- or 1,4-cyclohexanediol diacrylate, trimethylolpropane triacrylate, ditrimethylolpropane penta- or hexaacrylate, pentaerythritol tri- or tetraacrylate, glycerol di- or triacrylate, and also di- and polyacrylates of sugar alcohols, such as sorbitol, mannitol, diglycerol, threitol, erythritol, adonitol (ribitol), arabitol (Iyxitol), xylitol, dulcitol (galactitol), maltitol or isomalt, or of polyester polyols, polyetherols, poly THF having a molar mass of between 162 and 2000, poly-1,3-propanediol having a molar mass of between 134 and 1178, polyethylene glycol having a molar mass of between 106 and 898, and also epoxy (meth)acrylates, urethane (meth)acrylates or polycarbonate (meth)acrylates.

Further examples are (meth)acrylates of compounds of formula (XIa) to (XId)

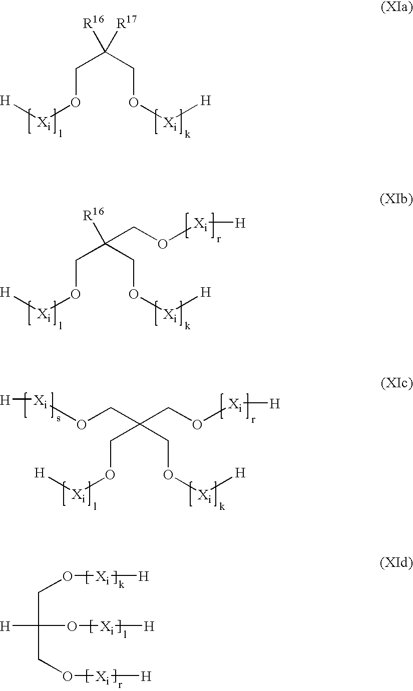

in which
R¹⁶ and R¹⁷ independently of one another are hydrogen or are C₁-C₁₈ alkyl which is unsubstituted or substituted by aryl, alkyl, aryloxy, alkyloxy, heteroatoms and/or heterocycles,
k, l, r, and s independently of one another are each an integer from 1 to 10, preferably 1 to 5, and more preferably 1 to 3, and
each Xᵢ for i=1 to k, 1 to 1, 1 to r, and 1 to s can be selected independently of one another from the group —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O—, and —CHPh-CH₂—O—, preferably from the group —CH₂—CH₂—O—, —CH₂—CH(CH₃)—O—, and —CH(CH₃)—CH₂—O—, and more preferably —CH₂—CH₂—O—,
in which Ph is phenyl and Vin is vinyl.
C₁-C₁₈ alkyl therein, unsubstituted or substituted by aryl, alkyl, aryloxy, alkyloxy, heteroatoms and/or heterocycles, is for example methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hetadecyl, octadecyl, 1,1-dimethylpropyl, 1,1-dimethylbutyl, 1,1,3,3-tetramethylbutyl, preferably methyl, ethyl or n-propyl, more preferably methyl or ethyl.

These are preferably (meth)acrylates of singly to vigintuply and more preferably triply to decuply ethoxylated, propoxylated or mixedly ethoxylated and propoxylated, and in particular exclusively ethoxylated glycerol, neopentyl glycol, trimethylolpropane, trimethylolethane or pentaerythritol.

Preferred multifunctional polymerizable compounds are ethylene glycol diacrylate, 1,2-propanediol diacrylate, 1,3-propanediol diacrylate, 1,4-butanediol diacrylate, 1,6-hexanediol diacrylate, trimethylolpropane triacrylate, pentaerythritol tetraacrylate, polyester polyol acrylates, polyetherol acrylates, and triacrylate of singly to vigintuply alkoxylated, more preferably ethoxylated, trimethylolpropane.

Very particularly preferred multifunctional polymerizable compounds are 1,4-butanediol diacrylate, 1,6-hexanediol diacrylate, trimethylolpropane triacrylate, pentaerythritol tetraacrylate, and triacrylate of singly to vigintuply ethoxylated trimethylolpropane.

Polyester polyols are known for example from Ullmanns Encyklopädie der technischen Chemie, 4th edition, volume 19, pp. 62 to 65. Preference is given to using polyester polyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids may be aliphatic, cycloaliphatic, araliphatic, aromatic or heterocyclic and may if appropriate be substituted, by halogen atoms for example, and/or unsaturated. Examples thereof that may be mentioned include the following:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄-alkyl esters for example, preferably methyl, ethyl or n-butyl esters, of said acids are used. Preference is given to dicarboxylic acids of the general formula HOOC—(CH₂)_{y}—COOH, y being a number from 1 to 20, preferably an even number from 2 to 20; more preferably succinic acid, adipic acid, sebacic acid, and dodecanedicarboxylic acid.

Suitable polyhydric alcohols for preparing the polyesterols include 1,2-propanediol, ethylene glycol, 2,2-dimethyl-1,2-ethanediol, 1,3-propanediol, 1,2-butanediol, 1,3-butanediol, 1,4-butanediol, 3-methylpentane-1,5-diol, 2-ethylhexane-1,3-diol, 2,4-diethyloctane-1,3-diol, 1,6-hexanediol, polyTHF having a molar mass between 162 and 2000, poly-1,3-propanediol having a molar mass between 134 and 1178, poly-1,2-propanediol having a molar mass between 134 and 898, polyethylene glycol having a molar mass between 106 and 458, neopentyl glycol, neopentyl glycol hydroxypivalate, 2-ethyl-1,3-propanediol, 2-methyl-1,3-propanediol, 2,2-bis(4-hydroxycyclohexyl)propane, 1,1-, 1,2-, 1,3-, and 1,4-cyclohexanedimethanol, 1,2-, 1,3- or 1,4-cyclohexanediol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which if appropriate may have been alkoxylated as described above.

Preferred alcohols are those of the general formula HO—(CH₂)ₓ—OH, x being a number from 1 to 20, preferably an even number from 2 to 20. Preference is given to ethylene glycol, butane-1,4-diol, hexane-1,6-diol, octane-1,8-diol, and dodecane-1,12-diol. Preference is further given to neopentyl glycol.

Also suitable, furthermore, are polycarbonatediols, such as may be obtained, for example, by reacting phosgene with an excess of the low molecular weight alcohols specified as constituent components for the polyester polyols.

Also suitable are lactone-based polyester diols, which are homopolymers or copolymers of lactones, preferably hydroxyl-terminated adducts of lactones with suitable difunctional starter molecules. Suitable lactones include, preferably, those deriving from compounds of the general formula HO—(CH₂)_{z}—COOH, z being a number from 1 to 20 and it being possible for an H atom of a methylene unit to have been substituted by a C₁ to C₄ alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components are the low molecular weight dihydric alcohols specified above as a constituent component for the polyester polyols. The corresponding polymers of ε-caprolactone are particularly preferred. Lower polyester diols or polyether diols as well can be used as starters for preparing the lactone polymers. In lieu of the polymers of lactones it is also possible to use the corresponding, chemically equivalent polycondensates of the hydroxy carboxylic acids corresponding to the lactones. The multifunctional polymerizable compound, may also comprise urethane (meth)acrylates, epoxy (meth)acrylates or carbonate (meth)acrylates.

Urethane (meth)acrylates are obtainable for example by reacting polyisocyanates with hydroxyalkyl (meth)acrylates or hydroxyalkyl vinyl ethers and, if appropriate, chain extenders such as diols, polyols, diamines, polyamines, dithiols or polythiols. Urethane (meth)acrylates which can be dispersed in water without addition of emulsifiers additionally comprise ionic and/or nonionic hydrophilic groups, which are introduced into the urethane by means of constituent components such as hydroxy carboxylic acids, for example.

Urethane (meth)acrylates of this kind comprise as constituent components substantially:
(a) at least one organic aliphatic, aromatic or cycloaliphatic di- or polyisocyanate,
(b) at least one compound having at least one isocyanate-reactive group and at least one free-radically polymerizable unsaturated group, and
(c) if appropriate, at least one compound having at least two isocyanate-reactive groups.

Components (a), (b), and (c) may be the same as those described above for the polyurethanes of the invention.

The urethane (meth)acrylates preferably have a number-average molar weight Mₙ of 500 to 20000, in particular of 500 to 10000 and more preferably 600 to 3000 g/mol (determined by gel permeation chromatography using tetrahydrofuran and polystyrene as standard).

The urethane (meth)acrylates preferably have a (meth)acrylic group content of 1 to 5, more preferably of 2 to 4, mol per 1000 g of urethane (meth)acrylate.

Epoxy (meth)acrylates are obtainable by reacting epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of possible epoxidized olefins include ethylene oxide, propylene oxide, iso-butylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene) (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene) (CAS No. [16096-30-3]) and of hydrogenated bisphenol A (2,2-bis[4-(2,3-epoxypropoxy)cyclohexyl]propane, CAS No. [13410-58-7]).

The epoxy (meth)acrylates and epoxy vinyl ethers preferably have a number-average molar weight Mₙ of 200 to 20000, more preferably of 200 to 10000 g/mol, and very preferably of 250 to 3000 g/mol; the amount of (meth)acrylic or vinyl ether groups is preferably 1 to 5, more preferably 2 to 4, per 1000 g of epoxy (meth)acrylate or vinyl ether epoxide (determined by gel permeation chromatography using polystyrene as standard and tetrahydrofuran as eluent).

Carbonate (meth)acrylates comprise on average preferably 1 to 5, especially 2 to 4, more preferably 2 to 3 (meth)acrylic groups, and very preferably 2 (meth)acrylic groups.

The number-average molecular weight Mₙ of the carbonate (meth)acrylates is preferably less than 3000 g/mol, more preferably less than 1500 g/mol, very preferably less than 800 g/mol (determined by gel permeation chromatography using polystyrene as standard, tetrahydrofuran as solvent).

The carbonate (meth)acrylates are obtainable in a simple manner by transesterifying carbonic esters with polyhydric, preferably dihydric, alcohols (diols, hexanediol for example) and subsequently esterifying the free OH groups with (meth)acrylic acid, or else by transesterification with (meth)acrylic esters, as described for example in EP-A 92 269. They are also obtainable by reacting phosgene, urea derivatives with polyhydric, e.g., dihydric, alcohols.

In an analogous way it is also possible to obtain vinyl ether carbonates, by reacting a hydroxyalkyl vinyl ether with carbonic esters and also, if appropriate, with dihydric alcohols.

Also conceivable are (meth)acrylates or vinyl ethers of polycarbonate polyols, such as the reaction product of one of the aforementioned diols or polyols and a carbonic ester and also a hydroxyl-containing (meth)acrylate or vinyl ether.

Examples of suitable carbonic esters include ethylene carbonate, 1,2- or 1,3-propylene carbonate, dimethyl carbonate, diethyl carbonate or dibutyl carbonate.

Examples of suitable hydroxyl-containing (meth)acrylates are 2-hydroxyethyl (meth)acrylate, 2- or 3-hydroxypropyl (meth)acrylate, 1,4-butanediol mono(meth)acrylate, neopentyl glycol mono(meth)acrylate, glyceryl mono- and di(meth)acrylate, trimethylolpropane mono- and di(meth)acrylate, and pentaerythritol mono-, di-, and tri(meth)acrylate.

Suitable hydroxyl-containing vinyl ethers are, for example, 2-hydroxyethyl vinyl ether and 4-hydroxybutyl vinyl ether.

Particularly preferred carbonate (meth)acrylates are those of the formula:

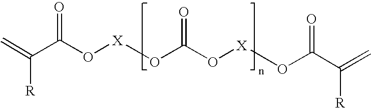

in which R is H or CH₃, X is a C₂-C₁₈ alkylene group, and n is an integer from 1 to 5, preferably 1 to 3.

R is preferably H and X is preferably C₂ to C₁₀ alkylene, examples being 1,2-ethylene, 1,2-propylene, 1,3-propylene, 1,4-butylene, and 1,6-hexylene, more preferably C₄ to C₈ alkylene. With very particular preference X is C₆ alkylene.

The carbonate (meth)acrylates are preferably aliphatic carbonate (meth)acrylates.

Among the multifunctional polymerizable compounds, urethane (meth)acrylates are particularly preferred.

Photoinitiators may be, for example, photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds), SITA Technology Ltd, London.

Suitability is possessed, for example, by mono- or bisacylphosphine oxides, as described for example in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO from BASF AG), ethyl 2,4,6-trimethylbenzoylphenylphosphinate (Lucirin® TPO L from BASF AG), bis(2,4,6-trimethylbenzoyl)phenylphosphine oxide (Irgacure® 819 from Ciba Spezialitätenchemie), benzophenones, hydroxyacetophenones, phenylglyoxylic acid and its derivatives, or mixtures of these photoinitiators. Examples that may be mentioned include benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-diisopropylthioxanthone, 2,4-dichlorothioxanthone, benzoin, benzoin isobutyl ether, chloroxanthenone, benzoin tetrahydropyranyl ether, benzoin methyl ether, benzoin ethyl ether, benzoin butyl ether, benzoin isopropyl ether, 7H-benzoin methyl ether, benz[de]anthracene-7-one, 1-naph-thaldehyde, 4,4′-bis(dimethylamino)benzophenone, 4-phenylbenzophenone, 4-chloro-benzophenone, Michler's ketone, 1-acetonaphthone, 2-acetonaphthone, 1-benzoyl-cyclohexan-1-ol, 2-hydroxy-2,2-dimethylacetophenone, 2,2-dimethoxy-2-phenylaceto-phenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2-diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraquinone, and 2-amylanthraquinone, and 2,3-butanedione.

Also suitable are nonyellowing or low-yellowing photoinitiators of the phenylglyoxalic ester type, as described in DE-A 198 26 712, DE-A 199 13 353 or WO 98/33761.

Preference among these photoinitiators is given to 2,4,6-trimethylbenzoyidiphenyl-phosphine oxide, ethyl 2,4,6-trimethylbenzoylphenylphosphinate, bis(2,4,6-tri-methylbenzoyl)phenylphosphine oxide, benzophenone, 1-benzoylcyclohexan-1-ol, 2-hydroxy-2,2-dimethylacetophenone, and 2,2-dimethoxy-2-phenylacetophenone.

The coating compositions of the invention are suitable especially for coating substrates such as wood, paper, textile, leather, nonwoven, plastics surfaces, glass, ceramic, mineral building materials, such as cement bricks and fiber cement slabs, and particularly metals, coated or uncoated.

Coating of the substrates with the coating compositions of the invention takes place in accordance with customary methods which are known to the skilled worker and involve applying a coating composition of the invention, or a coating formulation comprising it, to the target substrate in the desired thickness, and, if appropriate, drying it. This operation may if desired be repeated one or more times.

The coating materials may be applied one or more times by a very wide variety of application methods, such as compressed-air, airless or electrostatic spraying methods using one- or two-component spraying units, or else by injecting, troweling, knifecoating, brushing, rolling, rollercoating, pouring, laminating, injection-backmolding or coextruding.

The coating thickness is generally in a range from about 3 to 1000 g/m² and preferably 10 to 200 g/m².

Drying and curing of the coatings takes place in general under standard temperature conditions, i.e., without the coating being heated. Alternatively the mixtures of the invention can be used to produce coatings which, following application, are dried and cured at an elevated temperature, e.g., at 40-250° C., preferably 40-150° C., and in particular at 40 to 100° C. This is limited by the thermal stability of the substrate.

Drying and/or thermal treatment may also take place, in addition to or instead of the thermal treatment, by means of NIR radiation, which here refers to electromagnetic radiation in the wavelength range from 760 nm to 2.5 μm, preferably from 900 to 1500 nm.

Radiation curing takes place with high-energy light, UV light for example, or electron beams. Radiation curing may take place at relatively high temperatures. Preference is given in this case to a temperature above the T_{g} of the radiation-curable binder.

Radiation curing here is the free-radical polymerization of polymerizable compounds consequent upon electromagnetic and/or particulate radiation, preferably UV light in the wavelength range of λ=200 to 700 nm and/or electron beams in the range from 150 to 300 keV, and with particular preference with a radiation dose of at least 80, preferably 80 to 3000 mJ/cm².

Examples of suitable radiation sources for the radiation cure are low-pressure mercury lamps, medium-pressure mercury lamps with high-pressure lamps, and fluorescent tubes, pulsed lamps, metal halide lamps, electronic flash units, with the result that radiation curing is possible without a photoinitiator, or excimer lamps. The radiation cure is accomplished by exposure to high-energy radiation, i.e., UV radiation, or daylight, preferably light in the wavelength range of λ=200 to 700 nm, more preferably λ=200 to 500 nm, and very preferably λ=250 to 400 nm, or by exposure to high-energy electrons (electron beams; 150 to 300 keV). Examples of radiation sources used include high-pressure mercury vapor lamps, lasers, pulsed lamps (flash light), halogen lamps or excimer lamps. The radiation dose normally sufficient for crosslinking in the case of UV curing is in the range from 80 to 3000 mJ/cm².

It will be appreciated that a number of radiation sources can also be used for the cure: two to four, for example.

These sources may also emit each in different wavelength ranges.

In addition to radiation curing it is also possible for further curing mechanisms to be involved, examples being thermal curing, moisture curing, chemical curing and/or oxidative curing (dual-cure curing).

For the repair (self-healing) of the coatings of the invention the coatings are heated for a time of at least 10 minutes, preferably at least 15 minutes, more preferably at least 20 minutes, very preferably at least 30 minutes, with very particular preference at least 45 minutes, and in particular at least 60 minutes at a temperature which is at least 25° C., preferably at least 30° C., and more preferably at least 35° C. above their glass transition temperature.

Such heating can take place by treatment at a corresponding temperature (in a belt oven or other oven, for example) or may also take place, additionally or exclusively, by heating with NIR radiation, NIR radiation here being electromagnetic radiation in the wavelength range from 760 nm to 2.5 μm, preferably from 900 to 1500 nm.

The coating materials of the invention can be employed in particular as primers, surfacers, pigmented topcoat materials, and clearcoat materials in the segments of industrial coating, especially aircraft coating or large-vehicle coating, wood coating, automotive finishing, especially OEM finishing or refinishing, or decorative coating.

The compounds (A) in the coating compositions of the invention, as a result of the ready cleavability of the urethane groups they form, lead to a self-healing effect in the coatings. As a result of the silicon atoms which are present at the same time, especially siloxane groups, the scratch resistance of the coatings is raised at the same time.

The number of siloxane units is essential for optimization of the scratch resistance. If the number of siloxane units is too low, the scratch resistance is low. Consequently there ought to be at least three silicon atoms present that are joined to one another via siloxane bonds. Above a certain upper limit of siloxane units there is no further perceptible improvement in scratch resistance, so that a further increase in the number of silicon atoms no longer produces any advantage, but instead reduces the crosslinking density of the bonding groups (Y). Moreover, long siloxane units exhibit distinct incompatibilities with other coating-material components. Accordingly, up to 10 silicon atoms joined to one another by siloxane bonds are generally sufficient.

The present invention additionally provides for the use of compounds (A) as reaction partners with di- and polyisocyanates, and the reaction products obtained therewith. The advantage of such reaction products is that they are more readily cleavable back into the starting compounds than is the corresponding reaction product with a compound having primary hydroxyl groups. Consequently compounds (A) of this kind can be used as protective groups for compounds containing isocyanate groups, preferably di- and polyisocyanates (B). Also suitable for this purpose are compounds (A) which have only one or two silicon atoms, since in the context of use as protective groups the scratch resistance is not an important factor.

Therefore, in addition to the above-recited compounds (A), particularly the compounds (A) which are obtainable by reacting at least one compound (A1) which has at least one silicon atom and at least one Si—H group with at least one compound (A2) which carries at least one group (Y) and at least one vinylic group, and particularly those of the formulae (IIa), (IIb), and (IIIa) to (IIId), the following compounds of the formula (VIIIa) and (VIIIb) are suitable as well:

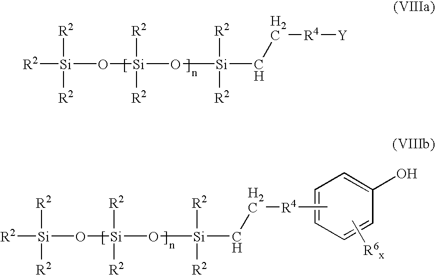

in which
R², R⁴, R⁵, R⁶, Y, n, and x can be as defined above.
ppm and percentage figures used in this specification are by weight unless otherwise indicated.

The examples below are intended to illustrate the invention but not to limit it to these examples.

### EXAMPLES

### Example 1

In a three-necked flask with reflux condenser and stirrer 123.15 g of eugenol (4-allyl-2-methoxyphenol) were admixed with 1.70 mg of sodium hydrogencarbonate with vigorous stirring and under inert gas. This initial charge was heated to 75° C. Then 8.70 g of DMS-H03 (hydride-terminated polydimethylsiloxane, Gelest, CAS No. 70900-21-9) and 0.52 ml of hexachloroplatinic acid hydrate (H₂[PtCl₆], 1% strength solution in toluene/isopropanol (1:1)) as catalyst were added. A weakly exothermic reaction was observed. Then the internal temperature was raised to 95° C. and 165.30 g of DMS-H03 (hydride-terminated polydimethylsiloxane, Gelest, CAS 70900-21-9) were added dropwise over the course of 60 minutes. The reaction mixture was stirred at 95 to 100° C. for 90 minutes. The course of the reaction and the conversion were monitored by infrared spectroscopy of the silicon hydride absorption band (Si—H, 2150 cm⁻¹). The end product had an OH number to DIN 53240 of 138 mg KOH/g.

### Example 2

In a three-necked flask with reflux condenser and stirrer 107.34 g of 2-allylphenol were admixed with 1.70 mg of sodium hydrogencarbonate with vigorous stirring and under inert gas. This initial charge was heated to 75° C. Then 9.28 g of DMS-H03 (hydride-terminated polydimethylsiloxane, Gelest, CAS 70900-21-9) and 0.64 ml of hexachloroplatinic acid hydrate (H₂[PtCl₆], 1% strength solution in toluene/isopropanol (1:1)) as catalyst were added. A weakly exothermic reaction was observed. Then the internal temperature was raised to 95° C. and 176.32 g of DMS-H03 (hydride-terminated polydimethylsiloxane, Gelest, CAS 70900-21-9) were added dropwise over the course of 60 minutes. The reaction mixture was stirred at 95 to 100° C. for 120 minutes. The course of the reaction and the conversion were monitored by infrared spectroscopy of the silicon hydride absorption band (Si—H, 2150 cm⁻¹). The end product had an OH number to DIN 53240 of 149 mg KOH/g.

### Example 3

An allophanate-functional polyisocyanate was prepared from 1,6-hexamethylene diisocyanate and 2-hydroxyethyl acrylate by a procedure analogous with that of example 1 of WO 00/39183, to give a polyisocyanate having an NCO content, following distillative removal of the unreacted monomeric 1,6-hexamethylene diisocyanate, of 15.1% by weight (residual monomer content <0.5% by weight), a viscosity of 940 mPas at 23° C., an average molecular weight of approximately 800 g/mol, and a double-bond density as determined via ¹H NMR of 2 mol/kg. The resulting urethane acrylate is referred to below as UA1.

In a three-necked flask with reflux condenser and stirrer, 207.31 g of the thus-prepared urethane acrylate UA1 were admixed with 149.45 g of siloxanediol (prepared according to example 1), 0.20 g of methylhydroquinone, and 0.40 g of 2,6-di-tert-butyl-p-cresol at room temperature. As a catalyst, 0.16 g of dibutyltin dilaurate was added to the thoroughly mixed initial charge. At this point a weakly exothermic reaction occurred, raising the internal temperature to around 30° C. The reaction mixture was stirred at 70° C. until its NCO value was 5.18%. Then 42.64 g of hydroxyethyl acrylate were added dropwise over the course of an hour. The reaction mixture was subsequently stirred at an internal temperature of 75° C. for two hours until the NCO value of the reaction mixture was 0.09%. The resultant urethane acrylate was diluted with 44.44 g of butyl acetate. The solids of the urethane acrylate was 88.0%. The double-bond density of the solvent-free urethane acrylate was 2.1 mol/kg.

### Example 4

In a three-necked flask with reflux condenser and stirrer, 213.20 g of urethane acrylate UA1 from example 3 were mixed with 142.35 g of siloxanediol (prepared according to example 2), 0.20 g of methylhydroquinone, and 0.40 g of 2,6-di-tert-butyl-p-cresol at room temperature. As a catalyst, 0.16 g of dibutyltin dilaurate was added to the thoroughly mixed initial charge. At this point a weakly exothermic reaction occurred, raising the internal temperature to around 30° C. The reaction mixture was stirred at 70° C. until its NCO value was 4.43%. Then 43.85 g of hydroxyethyl acrylate were added dropwise over the course of an hour. The reaction mixture was subsequently stirred at an internal temperature of 70° C. for three hours until the NCO value of the reaction mixture was 0.04%. The resultant urethane acrylate was diluted with 44.44 g of butyl acetate. The solids of the urethane acrylate was 88.0%. The double-bond density of the solvent-free urethane acrylate was 2.1 mol/kg.

### Comparative Example 1

In a three-necked flask with reflux condenser and stirrer, 321.85 g of urethane acrylate UA1 from example 3 were mixed with 151.22 g of CAPA® 2054 (polycaprolactonediol from Solvay, OH number =211 mg KOH/g), 0.27 g of methylhydroquinone, 0.54 g of 2,6-di-tert-butyl-p-cresol, and 59.92 g of butyl acetate at room temperature. As a catalyst, 0.22 g of dibutyltin dilaurate was added to the thoroughly mixed initial charge. At this point a weakly exothermic reaction occurred, raising the internal temperature to around 30° C. The reaction mixture was stirred at 70° C. until its NCO value was 4.30%. Then 66.20 g of hydroxyethyl acrylate were added dropwise over the course of an hour. The reaction mixture was subsequently stirred at an internal temperature of 70° C. for two hours until the NCO value of the reaction mixture was 0.02%. The resultant urethane acrylate was diluted with 35.30 g of butyl acetate. The solids of the urethane acrylate was 82.5%. The double-bond density of the solvent-free urethane acrylate was 1.2 mol/kg.

### Performance test 1

Determination of the performance properties of pendulum damping, Erichsen cupping, and scratch resistance.

The pendulum damping was determined along the lines of DIN 53157. For that purpose the radiation-curable compositions were applied to glass with a wet film thickness of 400 μm. The wet films were first flashed off at room temperature (23° C.) for 15 minutes and then dried at 100° C. for 20 minutes. The films obtained in this way were cured on an IST coating unit (type M 40 2×1-R-IR-SLC-So inert) with 2 UV lamps (high-pressure mercury lamps type M 400 U2H and type M 400 U2HC) and a conveyor belt speed of 10 m/min under a nitrogen atmosphere (O₂ not more than 500 ppm). The radiation dose was approximately 3800 mJ/cm². The higher the pendulum damping figure, the greater the hardness.

The Erichsen cupping was determined along the lines of DIN 53156. For this purpose the respective preparation of the invention was applied using a box-section coating bar to BONDER panel 132 with a wet film thickness of 200 μm. Curing was carried out by exposure as described above. Then the Erichsen cupping was determined by pressing a metal ball into the uncoated side of the panel. High values denote high flexibility.

The scratch resistance was determined by the scotch-brite test after storage for 7 days in a controlled-climate chamber. In the scotch-brite test, as the test element, a fiber web modified with silicon carbide and measuring 3×3 cm (scotch-brite SUFN from 3M) is attached to a cylinder. This cylinder presses the fiber web against the coating at 750 g and is moved over the coating pneumatically. The path length of the deflection is 7 cm. After 10 or 50 double rubs (DR) the gloss is measured in the middle area of the exposure (eightfold determination) along the lines of DIN 67530 with an incident angle of 20°. The residual gloss value in percent is given by the ratio of gloss after exposure to initial gloss. After 50 double rubs, the panel is wiped down gently twice with a soft cloth soaked with wash benzine and the residual gloss is measured again. Subsequently the reflow after 2 h at 80° C. in a drying oven is determined by measurement of the residual gloss.

The radiation-curable composition was prepared by intensely mixing 100 parts by weight of the urethane acrylates obtained in examples 3 and 4 and also comparative example 1 with 4 parts by weight of 1-hydroxycyclohexyl phenyl ketone (commercially customary photoinitiator Irgacure® 184 from Ciba Spezialitätenchemie).

| | | Erichsen cupping |
|---|---|---|
| | Pendulum damping [s] | [mm] |
| Example 3 | 105 | 3.9 |
| Example 4 | 97 | 5.2 |
| Comparative Example 1 | 67 | 4.1 |

| | | | | Residual | Residual |
|---|---|---|---|---|---|
| | | Residual | Residual | gloss [%] | gloss [%] |
| | Initial | gloss [%] | gloss [%] | after wash | after reflow |
| Example | gloss | after 10 DR | after 50 DR | benzine | 2 h 80° C. |
| 3 | 85.1 | 95.2 | 85.8 | 91.2 | 96.9 |
| 4 | 84.8 | 89.1 | 84.3 | 89.7 | 95.5 |
| Comp. 1 | 85.0 | 92.8 | 82.9 | 90.0 | 93.3 |

### Performance Test 2: Demonstration of the Self-Healing Effect by Means of DMTA Measurements

The radiation-curable composition was prepared by intensely mixing 100 parts by weight of the urethane acrylates obtained in example 3 and also comparative example 1 with 4 parts by weight of 1-hydroxycyclohexyl phenyl ketone (commercially customary photoinitiator Irgacure® 184 from Ciba Spezialitätenchemie). The radiation-curable compositions were applied to glass, using a box-section coating bar, with a wet film thickness of 100 μm. The wet films were first flashed off at 23° C. for 15 minutes and then dried at 100° C. for 20 minutes. The films obtained in this way were cured on an IST coating unit (type M 40 2×1-R-IR-SLC-So inert) with 2 UV lamps (high-pressure mercury lamps type M 400 U2H and type M 400 U2HC) and a conveyor belt speed of 10 m/min under a nitrogen atmosphere (O₂ not more than 500 ppm). The radiation dose was approximately 3800 mJ/cm².

The dynamic mechanical characteristics of the free films thus prepared and cured to completion, with a film thickness of 50-70 μm, were determined by means of dynamic mechanical thermo analysis (DMTA) at a heating rate of 2° C./min and a frequency of 1 Hz. The temperature range of the DMTA measurement was −30° C. to 200° C., the temperature being held at 150° C. for 60 min (instrument: Rheometrics Solids Analyzer RSA II; sample geometry: length: 34.5 mm, width: 6.0 mm; thickness 0.051 mm to 0.071 mm).

In the case of coating based on the silyl-containing urethane acrylate prepared in example 3, a tan δ maximum was measured at 90° C. In the elastomeric range (T>120° C., storage modulus 10⁸ Pa) a reduction in the storage modulus (elasticity modulus) was apparent from 150° C. to 10⁵ Pa at 200° C. This shows the chemical splitting of the network, which is responsible for the self-healing effect.

The coating based on the urethane acrylate from comparative example 1 did not show this behavior. A tan δ maximum was measured at 65° C. The storage modulus in the elastomeric range (T>80° C.) was 10⁸ Pa in the temperature range up to 200° C.

1. A coating composition comprising as constituent components
(A) at least one compound having at least one silicon atom and at least one isocyanate-reactive group (Y) whose reaction product with isocyanate is more readily cleavable than the corresponding reaction product with a compound having primary hydroxyl groups, wherein the isocyanate-reactive groups (Y) are selected from the group consisting of phenols, imidazoles, triazoles, pyrazoles, oximes, N-hydroxyimides, hydroxybenzoic esters, lactams, CH-acidic cyclic ketones, malonic esters, and alkyl acetoacetates and also, if appropriate, having at least one further isocyanate-reactive group (Z), which is different from (Y), and
(B) at least one nonblocked or blocked di- or polyisocyanate.

2. The coating composition according to claim 1, wherein the isocyanate-reactive groups (Y) are selected from the group consisting of phenols, oximes, N-hydroxyimides, lactams, imidazoles, triazoles, malonic esters, and alkyl acetonates.

3. The coating composition according to claim 1, wherein compound (A) comprises 2 to 20 groups (Y).

4. The coating composition according to claim 1, wherein up to 5 mol of groups (Y) are present in compound (A) per kg of compound (A).

5. The coating composition according to claim 1, wherein the compound (A) has 1 to 50 silicon atoms.

6. The coating composition according to claim 1, wherein the compound (A) is obtainable by reacting at least one compound (A1) having at least one silicon atom and at least one Si—H group with at least one compound (A2) which carries at least one group (Y) and at least one vinylic group.

7. The coating composition according to claim 6, wherein the compound (A1) has the formula (II) 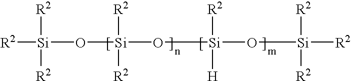
or formula (III) 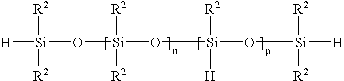
in which
R² radicals can each independently be hydroxyl (—OH), C₁-C₁₈ alkyl, C₆-C₁₂ aryl, C₅-C₁₂ cycloalkyl, C₁-C₁₈ alkoxy, and C₆-C₁₂ aryloxy,
n can be an integer from 0 to 50,
m can be an integer from 1 to 50, and
p can be an integer from 0 to 50.

8. The coating composition according to claim 6, wherein the compound (A2) has the formula (IV)
Vin-R⁴—Y
in which
Vin is a vinylic group,
R⁴ is a single bond, an oxygen atom, a nitrogen atom, C₁-C₂₀ alkylene, C₆-C₁₂ arylene, C₃-C₁₂ cycloalkylene, or C₂-C₂₀ alkylene which is interrupted by one or more oxygen and/or sulfur atoms and/or by one or more substituted or unsubstituted imino groups and/or by one or more —(CO)—, —O(CO)O—, —(NH)(CO)O—, —O(CO)(NH)—, —O(CO)— or —(CO)O— groups, and
Y is a group (Y).

9. The coating composition according to claim 6, wherein the compound (A2) has the formula (VI) 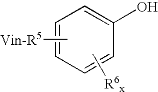
in which
Vin is a vinylic group,
R⁵ is a single bond, an oxygen atom, a nitrogen atom or C₁-C₂₀ alkylene,
R⁶ radicals each independently are x like or different radicals selected from the group consisting of hydroxyl (—OH), C₁-C₂₀ alkyl, C₁-C₂₀ alkyloxy, and C₆-C₁₂ aryloxy, and
x is an integer from 0 to 4.

10. The use of a coating composition according to claim 1 for producing a coating exhibiting an effect of repairability by introduction of energy.

11. A coating obtainable by mixing and reacting binder components (A) and (B) according to claim 1.

12. The coating according to claim 11, having a glass transition temperature of −30 to 120° C.

13. A method of thermally treating a coating according to claim 11, which comprises heating the coating for a time of at least 10 minutes at a temperature at least 25° C. above the glass transition temperature of the coating.

14. The method according to claim 13, wherein heating takes place using NIR radiation.

15. A compound of the formula 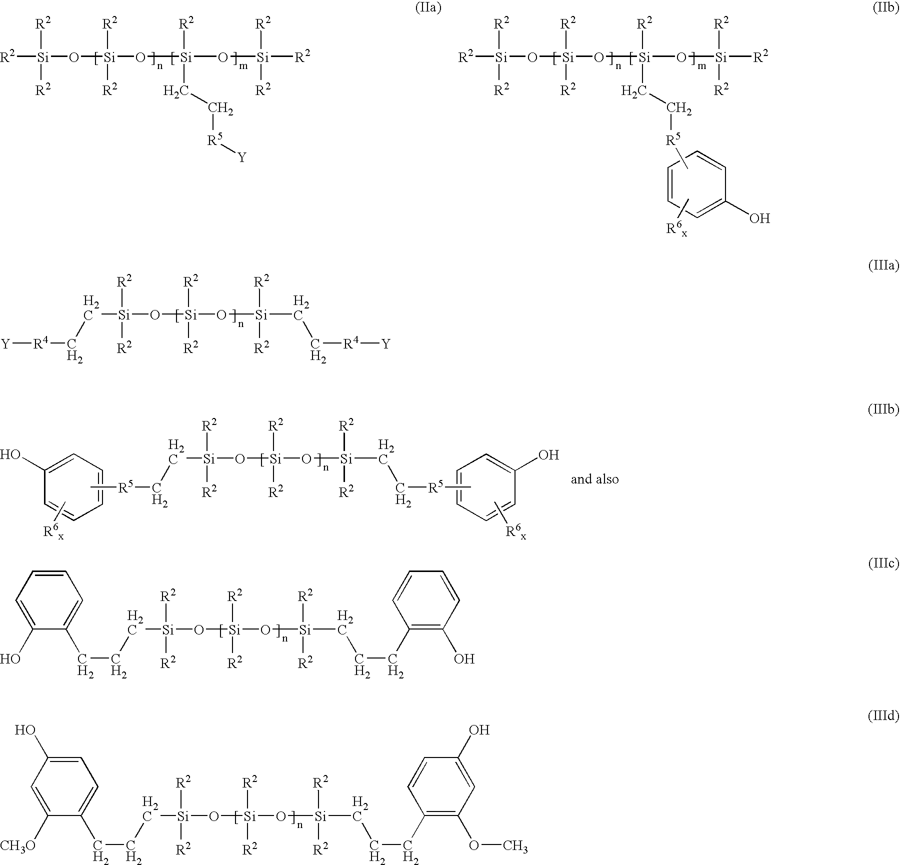
in which
R² radicals can each independently be hydroxyl (—OH), C₁-C₁₈ alkyl, C₆-C₁₂ aryl, C₆-C₁₂ cycloalkyl, C₁-C₁₈ alkoxy, and C₆-C₁₂ aryloxy,
R⁴ is a single bond, an oxygen atom, a nitrogen atom, C₁-C₂₀ alkylene, C₆-C₁₂ arylene, C₃-C₁₂ cycloalkylene, or C₂-C₂₀ alkylene which is interrupted by one or more oxygen and/or sulfur atoms and/or by one or more substituted or unsubstituted imino groups and/or by one or more —(CO)—, —O(CO)O—, —(NH)(CO)O—, —O(CO)(NH)—, —O(CO)— or —(CO)O— groups, and
R⁵ is a single bond, an oxygen atom, a nitrogen atom or C₁-C₂₀ alkylene,
R⁶ radicals each independently are x like or different radicals selected from the group consisting of hydroxyl (—OH), C₁-C₂₀ alkyl, C₁-C₂₀ alkyloxy, and C₆-C₁₂ aryloxy, and
Y is an isocyanate-reactive group whose reaction product with isocyanate is more readily cleavable than the corresponding reaction product with a compound
having primary hydroxyl groups,
n is an integer from 0 to 50,
m is an integer from 1 to 50, and
x is an integer from 0 to 4 wherein the isocyanate-reactive groups (Y) are selected from the group consisting of phenols, oximes, N-hydroxyimides, lactams, imidazoles, triazoles, malonic esters, and alkyl acetonates.

16. The use of a compound according to claim 15 as a reaction partner with di- and polyisocyanates.

17. A reaction product obtained by reacting a compound according to claim 15 with di- and polyisocyanates.

18. The use of a compound according to claim 15 or compounds of the formula (VIIIa) and (VIIIb) 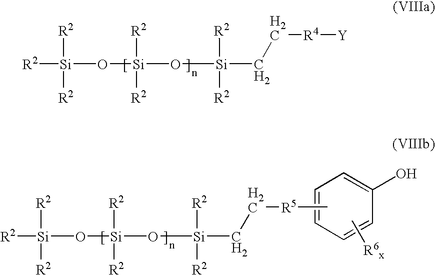
in which
R², R⁴, R⁵, R⁶, Y, n and x are as defined in claim 15
as protective groups for compounds containing isocyanate groups.

19. A reaction product (G) of compounds (A), according to claim 1, with at least one isocyanate compound having at least one isocyanate group.

20. A compound (G) according to claim 19, characterized in that the isocyanate compound is selected from the group consisting of diisocyanates, polyisocyanates containing isocyanurate groups, and polyisocyanates containing allophanate groups.

21. A compound of the formula 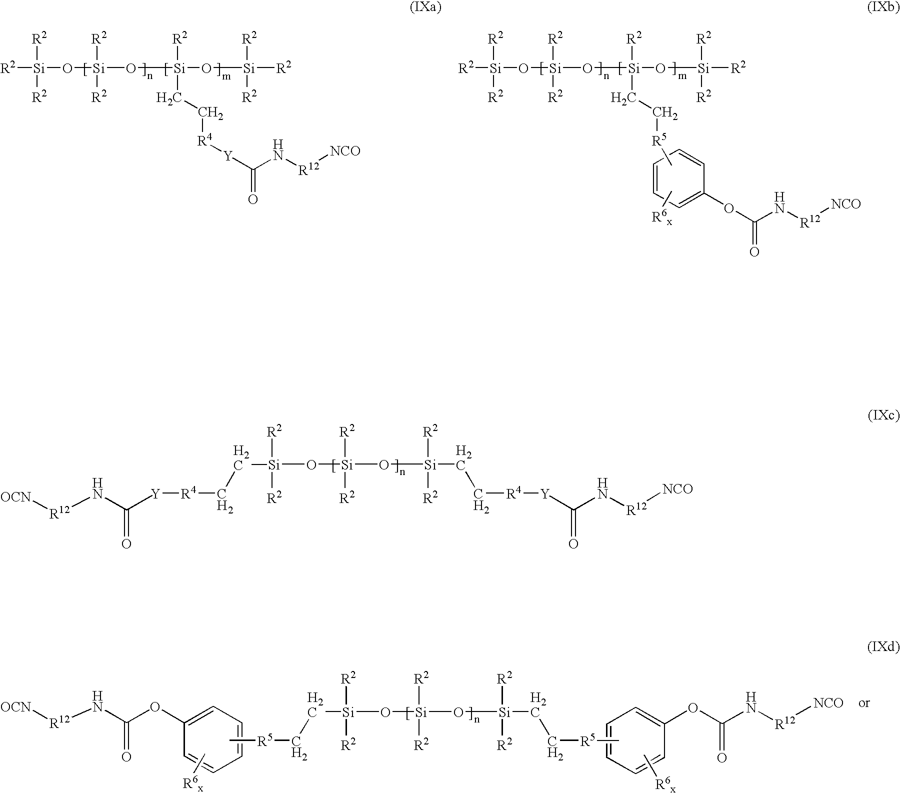 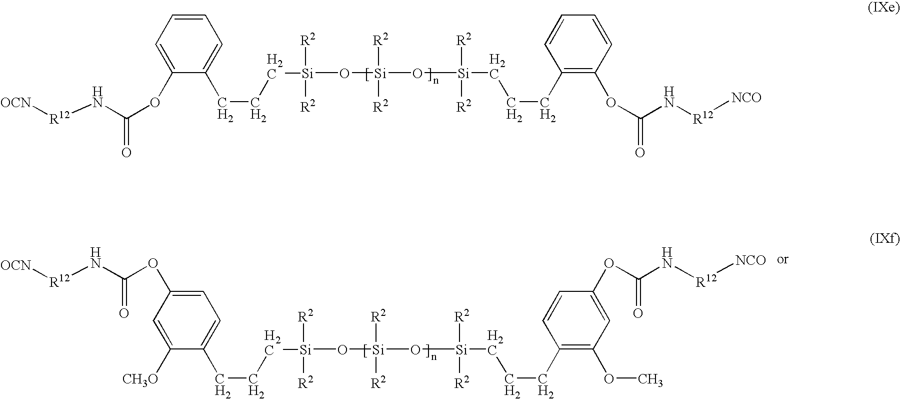 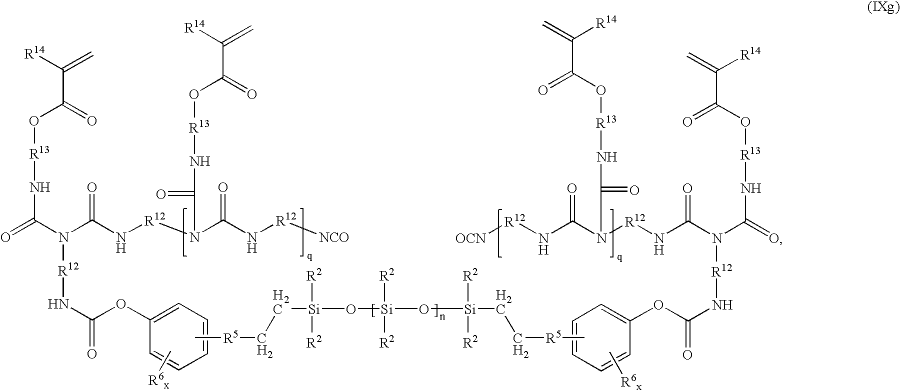
in which
the variables R², R⁴, R⁵, R⁶, n, m, x and Y are as defined in claim 1,
R¹² is a divalent aromatic, aliphatic or cycloaliphatic organic radical comprising 2 to 20 carbon atoms,
R¹³ is a divalent aliphatic or cycloaliphatic radical containing 1 to 8 carbon atoms,
R¹⁴ is hydrogen or methyl, and
q is a positive integral or on average fractional real number of at least 1.

22. A reaction product (H) of compounds (G) according to claim 19 with compounds which contain at least one isocyanate-reactive group and at least one free-radically polymerizable group.

23. A compound (H) according to claim 22, wherein the isocyanate-reactive group is hydroxyl (OH).

24. The compound (H) according to claim 22, wherein the at least one free-radically polymerizable group is selected from the group consisting of vinyl ether groups, acrylate groups, and methacrylate groups.

25. The compound (H) according to claim 22, wherein the compounds which contain at least one isocyanate-reactive group and at least one free-radically polymerizable group are selected from the group consisting of 2-hydroxyethyl (meth)acrylate, 2-hydroxypropyl (meth)acrylate, 3-hydroxypropyl (meth)acrylate, 1,4-butanediol mono(meth)acrylate, neopentylglycol mono(meth)acrylate, 1,5-pentanediol mono(meth)acrylate, 1,6-hexanediol mono(meth)acrylate, glycerol mono- and di(meth)acrylate, trimethyloipropane mono- and di(meth)acrylate, pentaerythritol mono-, di-, and tri(meth)acrylate, and 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl-(meth)acrylamide, 2-aminopropyl(meth)acrylamide, 3-aminopropyl(meth)-acrylamide, 2-hydroxyethyl(meth)acrylamide, 2-hydroxypropyl(meth)acrylamide and 3-hydroxypropyl(meth)acrylamide.

26. A compound of the formula 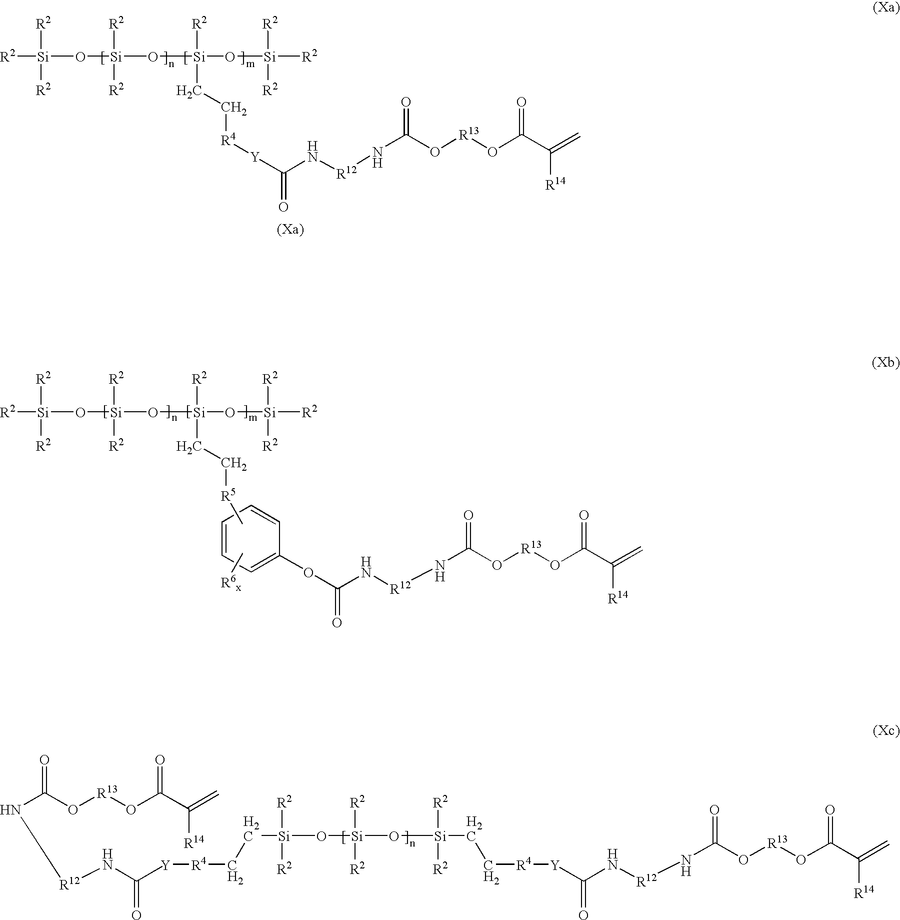 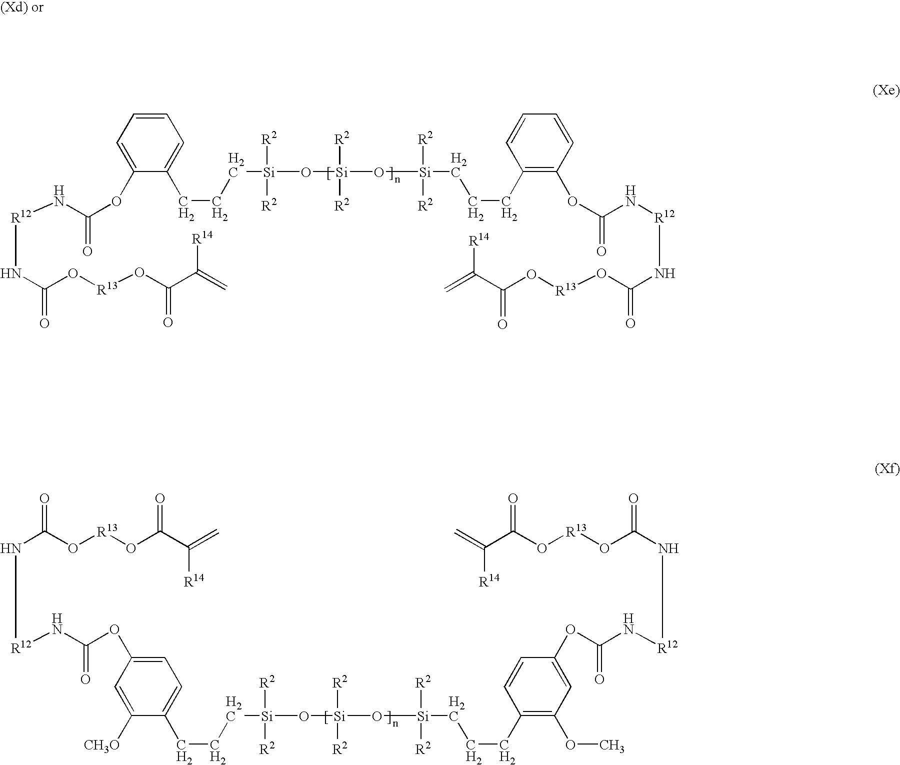 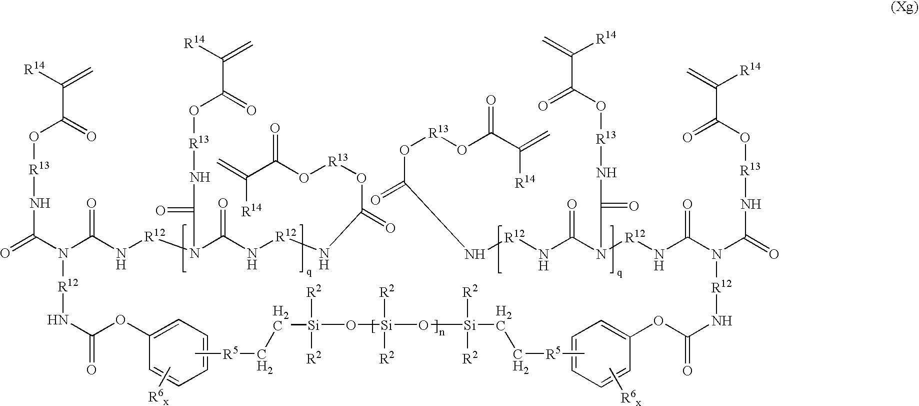
in which the variables are defined as in claim 1.

27. The use of a compound (G) according to claim 19 in one- or two-component polyurethane coating materials.

28. The use of a compound (H) according to claim 23 in radiation curing and in radiation-curable coating materials.
